(19) United States
(12) Patent Application Publication
(10) Pub. No.: US 2005/0009967 A1
(43) Pub. Date: Jan. 13, 2005

(54) Phosphite stabilizers and methods to preparation and polymer composition thereof

(76) Inventors: Hayder Zahalka, Morgantown, WV (US); Carloss L. Gray, Fairmont, WV (US); Vaikunth S. Prabhu, Morgantown, WV (US); Marshall D. Moore, Middlebury, CT (US)

Correspondence Address: Michael P. Dilworth;CROMPTON CORPORATION, Benson Road, Middlebury, CT, 06749, US

(21) Appl. No.: 10/860,706

(22) Filed: Jun. 3, 2004

Related U.S. Application Data
(60) Provisional application No. 60/534,471, filed on Jan. 2, 2004.
(60) Provisional application No. 60/414,530, filed on Jun. 12, 2003.

(51) Int. Cl. C08K 5/49; C07F 9/02

(52) U.S. Cl. 524/116; 568/12

(57) ABSTRACT

A process for the preparation of a neo diol phosphite stabilizer by a direct/solvent-less method, wherein a neoalkyl chlorophosphite is reacted directly with a mono- or di-substituted hydroxylated aromatic compound, for neo diol phosphite product having little or no odor is provided. Also provided are polymeric compositions comprising a stabilizing amount of a neo diol phosphite having low to no odor.

### CROSS REFERENCE TO RELATED APPLICATION

This application claims priority to Provisional Application No. 60/534,471, filed Jan. 2, 2004 and to Provisional Application No. 60/414,530, filed Jun. 12, 2003, the contents of which are incorporated by reference herein.

### BACKGROUND OF THE INVENTION

1. Field of the Invention

The present invention generally relates to compositions and stabilizers for polymeric resin compositions, and more particularly to stabilized resin compositions and stabilizer concentrates for resin compositions.

2. Description of the Related Art

The need for stabilization of polymeric compositions is known, and the use of compounds such as hydroxyl amines, amine oxides, lactones, hindered phenolics, and phosphites as stabilizers is also well known.

Neoalkyl phenyl phosphites are known as stabilizers in the art. For example, U.S. Pat. No. 3,467,733 discloses the preparation of phosphites and diphosphites, such as bis(1,3,2-dioxaphosphorinyl-2-oxy)aryl alkenes and mono-and bis (1,2,3-dioxaphosphorinanyl-2-oxy)benzenes, for use as stabilizers for organic compositions. U.S. Pat. No. 3,467,733 further discloses the reaction of a cyclic phosphorohalidite with a hydroxy aromatic compound, subsequently neutralizing the reaction product with a nitrogen containing compound such as ammonia and recovering the desired cyclic phosphite and diphosphite.

Another example is U.S. Pat. No. 3,714,302 which discloses the preparation of cyclic phosphites such as phenyl neopentyl phosphite by reacting phenol in the melt with a crude product of PCl₃ and a 2,2-di-lower alkyl-1,3-propane

glycol, and recovering the phosphites by distillation. In this reference, the substitutions (X,Y,Z) on phenol are independently selected from group consisting of —H and alkyl of 1-5 carbon atoms, and sum of the carbon atoms in X, Y, and Z does not exceed 5.

Other examples include U.S. Pat. Nos. 5,618,866 and 5,594,053 which disclose phosphite compositions derived from neodiol chlorophosphite and 2,4-di-substituted phenols using an amine acceptor. U.S. Pat. No. 5,786,497 discloses the preparation of phosphites from phenol with alkyl substitution at 2,4,and 6 position, with the reaction with chlorophosphite derivative being carried out in an excess amine medium (acceptor technology), subsequently followed by the removal of hydrogen chloride by forming amine hydrochloride.

Composition of matter comprising phosphites derived from 2,4-di-alkyl-phenol and pentaerythritol chlorophosphite and aliphatic polyamines in polyolefins are known in the art, see for example, U.S. Pat. No. 5,514,742. Specific compositions comprising phosphites derived from 2,4,6-tri-alkyl-phenol and neodiol is described in U.S. Pat. No. 5,424,348. Amorphous neodiol based phosphite compositions with polyamine are described in U.S. Pat. Nos. 5,674,927; 5,468,895; and 5,605,947.

U.S. Pat. No. 4,305,866 discloses stabilization of polyolefin with a phosphite. The phosphites in the prior art are prepared by a direct method, wherein the phosphite is obtained by the reaction of a neoglycol with PCl₃ in the absence of a catalyst, HCl acceptor and solvent. HCl is liberated in the process to form the phosphite derivative, e.g., triplienylphosphite synthesis from phenol and PCl3. The phosphites in the prior art can also be prepared by another process, a trans-esterification method in which triphenylphosphite is reacted with an alcohol, and the phenol is liberated and distilled.

U.S. Pat. No. 5,618,866 discloses yet another process to manufacture phosphite stabilizers, i.e., an acceptor technology, wherein chlorophosphorohalidite is prepared by reacting alcohol or phenol with PCl₃, and then this is reacted with an alcohol or phenol in presence of an amine catalyst to form the phosphite derivative. Amine hydrochloride salts are then isolated from the product of the intermediate reaction.

The phosphite stabilizers in the prior art, i.e., hindered neoalkyl phosphite compositions as disclosed in U.S. Pat. No. 5,464,889, are obtained in the presence of a solvent and have undesirable odors, which make the handling and processing of the materials unpleasant.

A low odor phosphite stabilizer would be an advancement in the art. Applicants have developed a solvent-less process for making neo diol phosphite esters for phosphite stabilizer products with surprisingly low odor levels.

There is a need for a cost effective simplified method of preparation of the neoalkyl aryl phosphite with improved handling properties by eliminating extra steps and elimination of storage/recovery/purification/recycle of intermediates. There is also a need for neoalkyl phenyl phosphite compositions exhibiting improved thermal, hydrolytic stability in polymers. Applicants have found a process to produce phosphites from 2,4-dialkyl or 2,4-di-alkylaryphenol and neodiol based chlorophosphites by direct reaction, for a phosphite product that surprisingly has no odor or low in odor, particularly useful in thermoplastic compositions such as polyolefins.

### SUMMARY OF THE INVENTION

The present invention relates to a process for the preparation of a neo diol phosphite stabilizer by a direct or solvent-less method, comprising the steps of reacting a neoalkyl chlorophosphite with a mono- or di-substituted hydroxylated aromatic compound which is present in excess amount at a temperature of about 40 to about 250° C., removing HCl by applying controlled vacuum or by sweeping the HCl gas under nitrogen or a stream of an inert gas, and finally removing the respective excess of hydroxylated aromatic compound and neo diol phosphite from the reaction mixture under reduced pressure.

The present invention further relates to a neo diol phosphite stabilizer prepared by a direct or solvent-less process, wherein the phenol is substituted at the 2- and 4-position with an alkyl or alkylaryl group and the stabilizer is characterized as having a low odor or no odor.

The present invention also relates to polymeric compositions comprising a stabilizing effective amount of a low odor or no odor neo diol phosphite stabilizer prepared by a direct or solvent-less process.

The present invention further relates to a thermoplastic composition stabilized against degradation, said composition comprising: (a) a thermoplastic resin or mixture thereof; (b) a low odor or no odor neo diol phosphite stabilizer; and (c) a stabilizing effective amount of a stabilizer or a mixture of stabilizers selected from the group consisting of the phenolic antioxidants, the hindered amine light stabilizers, the ultraviolet light stabilizers, the organic phosphorus compounds, the alkaline metal salts of fatty acids, the hydroxylamines, tertiary amine oxides, the 3-arylbenzofuranones, and the thiosynergists.

In another embodiment, the present invention also pertains to stabilized compositions wherein component (a) is a polyolefin resin or mixture thereof.

In yet another embodiment of the present invention stabilized compositions are provided wherein component (c) comprises: (x) a stabilizing amount of a phenolic antioxidant or mixture thereof; or (y) a stabilizing amount of a phenolic antioxidant or mixture thereof in combination with a stabilizing amount of: (i) an organic phosphorus compound or mixture thereof; or (ii) a hindered amine stabilizer or mixture thereof; or (iii) a thiosynergist or mixture thereof; or (iv) an ultraviolet light absorber or mixture thereof; or (v) a hindered amine stabilizer and an organic phosphorus compound or mixtures thereof; or (vi) a hindered amine stabilizer, a thiosynergist and an organic phosphorus compound or mixtures thereof; or (vii) an ultraviolet light absorber and a hindered amine stabilizer or mixtures thereof; or (vii) an ultraviolet light absorber and an organic phosphorus compound or mixtures thereof; or (ix) an alkaline metal salt of a fatty acid or mixture thereof; or (x) a hydroxyl amine or mixture thereof, or xi) tertiary amine oxide or mixture thereof, (xii) a stabilizing amount of a hindered amine stabilizer or mixture thereof, or (xiii) a stabilizing amount of an alkaline metal salt of a fatty acid or mixture thereof; or (xiv) a stabilizing amount of a 3-arylbenzofuranones or mixture thereof, or (xv) a stabilizing amount of an hydroxylamine or mixture thereof, or (xvi) a stabilizing amounts of tertiary amine oxide or mixture thereof.

Other combinations are also envisioned in the present invention.

### BRIEF DESCRIPTION OF THE DRAWINGS

The above and other features, advantages and objects of the invention will become more readily apparent from the description of the preferred embodiments accompanied by the following drawings, in which:

FIG. 1 is a comparison of the melt flow control observed from chromium-catalyzed high density polyethylene with phosphites both within (Example 17) and outside (Comparative Examples 13 and 14) the scope of the invention;

FIG. 2 is a graphical comparison of the color observed from chromium-catalyzed high density polyethylene with phosphites both within (Example 17) and outside (Comparative Examples 13 and 14) the scope of the invention;

FIG. 3 is a graphical comparison of the color observed from chromium-catalyzed high density polyethylene with phosphites both within (Example 17) and outside (Comparative Examples 13 and 14) the scope of the invention, when exposed to NOx gases; the color of the chromium-catalyzed polyethylene samples being shown as the yellowness index over the number of days of exposure to the NOx gases;

FIG. 4 is a graphical comparison of the thermal aging observed over a twenty day period for a chromium-catalyzed high density polyethylene with phosphites both within (Example 17) and outside (Comparative Examples 13 and 14) the scope of the invention; when placed in an oven at 60° C., the thermal aging of the chromium-catalyzed polyethylene samples being shown as the yellowness index over the number of days in the oven at 60° C.;

FIG. 5 is a comparison of the melt flow stability observed from Ziegler Natta-catalyzed linear low density polyethylene with phosphites both within (Example 18) and outside (Comparative Examples 15 and 16) the scope of the invention;

FIG. 6 is a graphical comparison of the color observed from Ziegler Natta-catalyzed linear low density polyethylene with phosphites both within (Example 18) and outside (Comparative Examples 15 and 16) the scope of the invention; the color of the Ziegler Natta-catalyzed linear low density polyethylene samples being shown as the yellowness index over the first, third and fifth multipass extrusion;

FIG. 7 is a graphical comparison of the gas fading observed from Ziegler Natta-catalyzed linear low density polyethylene with phosphites both within (Example 18) and outside (Comparative Examples 15 and 16) the scope of the invention, when exposed to NOx gases; the gas fading of the Ziegler Natta-catalyzed linear low density polyethylene samples being shown as the yellowness index over the number of hours of exposure to the NOx gases;

FIG. 8 is a comparison of the melt flow observed from metallocene-catalyzed linear low density polyethylene with phosphites both within (Example 19) and outside (Comparative Examples 17 and 18) the scope of the invention;

FIG. 9 is a graphical comparison of the color observed from metallocene-catalyzed linear low density polyethylene with phosphites both within (Example 19) and outside (Comparative Examples 17 and 18) the scope of the invention; the color of the metallocene-catalyzed linear low density polyethylene samples being shown as the yellowness index over the first, third and fifth multipass extrusion;

FIG. 10 is a graphical comparison of the color observed from metallocene-catalyzed linear low density polyethylene with phosphites both within (Example 19) and outside (Comparative Examples 17 and 18) the scope of the invention, when exposed to NOx gases; the color of the metallocene-catalyzed linear low density polyethylene samples being shown as the yellowness index over the number of days of exposure to the NOx gases;

FIG. 11 is a is a comparison of the melt flow observed from polypropylene with phosphites both within (Example 20) and outside (Comparative Examples 19 and 20) the scope of the invention;

FIG. 12 is a graphical comparison of the color observed from polypropylene with phosphites both within (Example 20) and outside (Comparative Examples 19 and 20) the scope of the invention; the color of the polypropylene samples being shown as the yellowness index over the first, third and fifth multipass extrusion; and,

FIG. 13 is a graphical comparison of the in polymer hydrolytic stability of phosphites within and outside the scope of the present invention at 60° C. over a 70 day period at 60° C. relative humidity.

### DETAILED DESCRIPTION OF THE INVENTION

Odor is that property of a substance that makes it perceptible to the sense of smell. Specifically, odor is that property that is manifested by a physiological sensation caused by contact of the molecules of a substance with the olfactory nervous system. The present invention relates to thermoplastic and thermoset compositions, and phosphite stabilizers for thermoplastic and thermoset compositions, and more particularly relates to improved phosphite stabilizers being low in odor or free in odor.

As used herein, by “stabilizing amount” or an “effective amount” of the phosphites of the invention is meant when the polymer composition containing the phosphites of the invention shows improved stability in any of its physical or color properties in comparison to an analogous polymer composition which does not include a phosphite of the invention. Examples of improved stability is meant improved stabilization against, for example, molecular weight degradation, color degradation, and the like from, for example, melt processing, weathering, and/or long term field exposure to heat, light, and/or other elements. In one example, an improved stability is meant one or both of lower initial color or additional resistance to weathering, as measured, for example, by initial yellowness index (YI), or by resistance to yellowing and change in color, when compared to a composition without the stabilizer additive.

As used herein, by “solvent-less” in the process of the presence invention is meant the absence of or without the requirement for a solvent as in the processes of the prior art, i.e., the reaction of a neoglycol chlorophosphite, with substituted phenols using HCl acceptor, e.g., amines, and using inert solvents such as, for example, toluene, heptane, xylene, methylene chloride, chloroform, benzene and the like. Solvent-less herein also refers to the absence of or without the need for a solvent in the reaction as compared to need of solvent as in case of a typical “acceptor technology” route. Other examples of such solvents include hindered alcohols, e.g., isopropyl alcohol, and tert-butylalcohol.

Phosphite Stabilizers

In one embodiment, the stabilizers of the present invention are selected from the group of 2,4-dialkyl-phenol derived phosphites, having the general formule A: 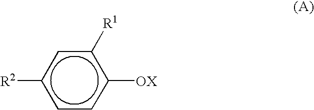
wherein the OX group is hindered by at least one R¹; R¹ and R² are independently alkyl groups having from 1 to 9 carbon atoms and wherein the R¹ and R²alkyl groups have a combined total of carbon atoms of at least 5. In one embodiment, R¹ and R² are secondary or tertiary branched alkyl groups. In another embodiment, R¹ and R² are selected from tertiary alkyl groups. In yet another embodiment for enhanced hydrolysis resistance, the R¹ group and a phenyl group or a substituted phenyl group are positioned at the respective ortho- and para-positions with respect to the OX group.

X can be of the following formula C: 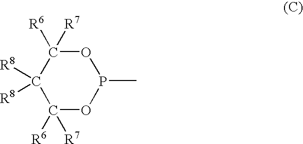
wherein R⁶ and R⁷ are independently hydrogen, halogen, or an alkyl group of from 1 to 3 carbon atoms and R⁸ is independently alkyl groups having 1 to 12 carbon atoms. In one embodiment, the R⁶ groups are hydrogen. In another embodiment, the alpha-carbon for the ring structure includes at least one hydrogen substituent. The above phosphite entities in one embodiment are formed from 1,3-alkane diols with the beta or 2-position being blocked by alkyl or cyclic alkyl groups. In another embodiment, X has the formulae:

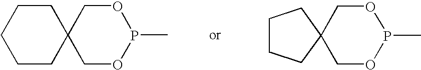

In one embodiment of the present invention, the phosphite stabilizer is a 2,4-dicumylphenol based phosphite structure of the general formula B:

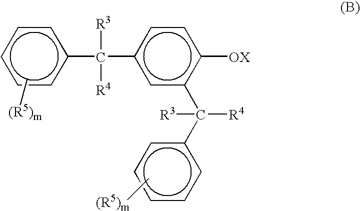

In one embodiment of the above compound, R³ and R⁴ are independently alkyl groups of from 1 to 6 carbon atoms. In another embodiment, R³ and R⁴ are independently a straight chain alkyl group. R⁵ in one embodiment is hydrogen, a halogen, or an alkyl group of from 1 to 12 carbon atoms. The integer m has a value from 0 to 5. The dicumyl group includes the OX group which is the phosphite portion. Generally, the OX group is hindered by only one alkyl aryl group at the ortho position, with the other ortho position being occupied by hydrogen.

In one embodiment, X has the following structure (C): 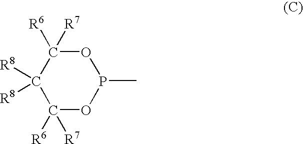
wherein R⁸ is independently alkyl groups having 1 to 12 carbon atoms; R⁶ and R⁷ are independently hydrogen, halogen, or an alkyl group of from 1 to 3 carbon atoms. In one embodiment, the R⁶ groups are hydrogen. In another embodiment, the alpha-carbon for the ring structure includes at least one hydrogen substituent. The above phosphite entities in one embodiment are formed from 1,3-alkane diols with the beta or 2-position being blocked by alkyl or cyclic alkyl groups.

In another embodiment, X has the following formulae: 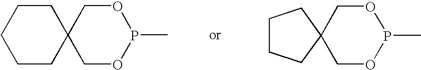
Direct/Solvent-less Process to Prepare Phosphite Stabilizers

The present invention further relates to a direct/solvent-less process for preparing the foregoing neo diol phosphite stabilizers. In one embodiment, the phenol is substituted at 2- and 4-position with an alkyl or alkylaryl group and is used in about 1 to about 30% excess by molar ratio with the removal of HCl gas. In another embodiment of the process of the present invention, excess of unreacted 2,4-di-substituted phenol and neodiol chlorophosphite is removed at the end of the reaction under reduced pressure, to advantageously provide a stabilizer product that has a low odor or no odor.

In yet another embodiment of the process of the present invention, chlorophosphite is added to the substituted phenol in the first about 0.1 to about 4 hours with the temperature of the addition being kept in the range of about 40 to about 80° C. The reaction is held generally for a time period ranging from about 5 to about 20 hours at a reduced pressure ranging from about 1 mm to about 100 mm with the removal of HCl gas or conducted by a sweep of an inert gas, e.g., nitrogen, helium or argon. At the end of the reaction, excess of the unreacted phenol and chlorophosphite may be removed by any conventional process, e.g., distillation process, under reduced pressure and at a temperature range of about 40° C. to about 250° C. The product is then isolated from the reactor, and can be further purified by distillation if liquid or crystallized from an organic solvent and dried.

In one embodiment of the process of the present invention, a neoalkyl chlorophosphite is reacted directly with a substituted phenol, e.g., a mono- or di-substituted hydroxylated aromatic compound, with or without the use of catalysts and at a temperature ranging from about 40° C. to about 250° C. under reduced pressure.

In another embodiment of the present invention, a catalyst may be used to enhance the reaction rate of the reaction between chlorophosphite intermediate and substituted phenol forming the corresponding phosphite derivative. In one embodiment, an amine such as, for example, tri-isopropanolamine, is added to the reaction to improve the hydrolytic stability of the end-product phosphite stabilizer depending on the intended use.

Examples of catalysts useful in the process of the present invention are those described in EP-A 0,000,757. Examples of catalysts of this type include compounds belonging to the group comprising amines or ammonium salts; amides of carboxylic acids or of carbonic acid; non-aromatic N-containing heterocyclic compounds and salts thereof, primary, secondary and tertiary phosphines and salts thereof ;or esters of phosphoric acids and phosphonic acids.

In one embodiment, the catalysts are selected from the amines and ammonium salts, amides and nitrogen-containing heterocyclic compounds or phosphines containing, as substituents, alkyl; cycloalkyl; aryl, e.g., phenyl; alkaryl, e.g., alkylated phenyl; aralkyl, e.g., benzyl; or alkaralkyl, e.g., alkylated benzyl, groups which preferably contain 1 to about 18 carbon atoms, and preferably 1 to about 12 carbon atoms, and are interrupted, if appropriate, by oxygen or sulfur atoms. Alkyl groups containing 1 to 6 carbon atoms, and cycloalkyl groups, e.g., cyclopentyl and cyclohexyl group, may be used.

The catalysts to be used in the form of salts are preferably the halides, e.g., chlorides. The salts can also be formed in situ by means of the hydrogen halide formed in the course of the process. Nevertheless, it is advantageous in certain cases to employ the salts themselves as catalysts. The amines and ammonium salts comprise one catalyst group. Examples include primary, secondary and tertiary amine salts. The salts also include the quaternary ammonium salts. In one embodiment, catalysts are in the form of secondary amines, e.g., their salts and the quaternary ammonium salts. In another embodiment, the catalysts are in the form of alkyl-substituted and cycloalkyl-substituted amines or ammonium salts. In yet another embodiment, catalysts are selected from the group of methylamine, ethylamine, propylamine, n-butylamine, t-butylamine, pentylamine, octylamine, dodecylamine, phenylamine, benzylamine, dimethylamine, diethylamine, methylethylamine, methylbutylamine, methyoctylamine, methylphenylamine, ethylbenzylamine, trimethylamine, triethylamine, tributylamine, octyldimethylamine, dimethylphenylamine, tetramethylamonium, trimethylethylamonium, triethylmethylamonium, tributylmethylamonium, tetrabutylamonium, trimethyloctylamonium, triphenylmethylamonium and tribenzylmethylammonium chloride, bromide or iodide. In a third embodiment, catalysts are in the form of ammonium salts such as, for example, methylammonium, octylammonium, dimethylammonium, methylcyclohexylammonium, dibenzylammonium, diphenylammonium, trimethylammonium, tributylammonium, tribenzylammonium and triphenylammonium chloride, bromide and iodide.

The amides of carboxylic acids constitute another group of catalysts. This group also includes the ureas and their bisurea derivatives. The amides can be derived from polyfunctional, preferably monofunctional, carboxylic acids containing, in particular, 1 to 14 carbon atoms. The amides can also be derived from aromatic N-heterocyclic compounds. Cyclic amides, for example epsilon-caprolactam, are also suitable. Examples include formamide, oxamide, dimethylformamide, acetamide, N,N-dimethylkacetamide, picoanilide, benzamide, terephthalamide, and trimallitamide. The preferred catalysts include independently N,N-dimethylformamide, N,N-dimethylacetamide, and N-methylpyrrolidone or mixture thereof.

The catalyst can be employed in amounts of, for example, about 0.0001 to about 10 mol. % range relative to the reactants.

Any HCl gas generated may be pulled from the reaction vessel out by applying low vacuum pressure, e.g., in the range of about 10 to about-140 torr Hg, to just remove the HCl and not the raw materials from the reactor. In another embodiment, the HCl gas is removed by sweeping with an inert gas such as dry nitrogen or Argon. At the end of the reaction, e.g., after the conversion to phosphite product is at least 70% completion, excess of the unreacted phenol and chlorophosphite is removed by distillation process under reduced pressure. In another embodiment, excess of the unreacted phenol and chlorophosphite is removed after the reaction is at least 75% complete.

The phosphite product is isolated in high yields (90+%) and in high purity (90+%). The phosphites as isolated may be used directly in the liquid form. In another embodiment, the phosphite product undergoes an additional distillation step for further purification and use in the solid form by imbibing on microporous resins such as, for example, Accurel® resin (Membrana GmbH).

In one embodiment, the phosphite product of the invention is used in a stabilizing amount of about 50 ppm to about 5 weight percent, preferably about 0.001 to about 2 weight percent and most preferably from about 0.0025 to about 1 weight percent, based on the total weight of the resin composition.

Polymers Stabilized by the Phosphites of the Invention

A number of resins, also referred to as polymeric resins, may be stabilized by the phosphites of the present invention. The polymers may be any thermoplastic known in the art, such as polyolefin homopolymers and copolymers, polyesters, polyurethanes, polyalkylene terephthalates, polysulfones, polyimides, polyphenylene ethers, styrenic polymers and copolymers, polycarbonates, acrylic polymers, polyamides, polyacetals and halide containing polymers. Mixtures of different polymers, such as polyphenylene ether/styrenic resin blends, polyvinyl chloride/ABS or other impact modified polymers, such as methacrylonitrile and alpha-methylstyrene containing ABS, and polyester/ABS or polycarbonate/ABS and polyester plus some other impact modifier may also be used. Such polymers are available commercially or may be made by means well known in the art. However, the benzimidazole additive compounds and stabilizer compositions of the invention are particularly useful in thermoplastic polymers, such as polyolefins, polycarbonates, polyesters, polyphenylene ethers and styrenic polymers, due to the extreme temperatures at which thermoplastic polymers are often processed and/or used.

Polymers of monoolefins and diolefins for use herein include, but are not limited to, polyethylene ((which optionally can be crosslinked), polypropylene, polyisobutylene, polybutene-1, polymethylpentene-1, polyisoprene, or polybutadiene, as well as polymers of cycloolefins, e.g., cyclopentene or norbornene. Mixtures of these polymers, for example, mixtures of polypropylene with polyisobutylene, polypropylene with polyethylene (e.g., PP/HDPE, PP/LDPE) and mixtures of different types of polyethylene (e.g., LDPE/HDPE), may also be used. Also useful are copolymers of monoolefins and diolefines with each other or with other vinyl monomers, such as, for example, ethylene/propylene, LLDPE and its mixtures with LDPE, propylene/butene-1, ethylene/hexene, ethylene/ethylpentene, ethylene/heptene, ethylene/octene, propylene/isobutylene, ethylene/butane-1, propylene/butadiene, isobutylene, isoprene, ethylene/alkyl acrylates, ethylene/alkyl methacrylates, ethylene/vinyl acetate (EVA) or ethylene/acrylic acid copolymers (EAA) and their salts (ionomers) and terpolymers of ethylene with propylene and a diene, such as hexadiene, dicyclopentadiene or ethylidene-norbornene; as well as mixtures of such copolymers and their mixtures with polymers mentioned above, for example, polypropylene/ethylene propylene-copolymers, LDPE/EVA, LDPE/EAA, LLDPE/EVA, and LLDPE/EAA.

The olefin polymers may be produced by, for example, polymerization of olefins in the presence of Ziegler-Natta catalysts optionally on supports such as, for example, Mg Cl₂, chronium salts and complexes thereof, silica, silica-alumina and the like. The olefin polmers may also be produced utilizing chromium catalysts or single site catalysts, e.g., metallocene catalysts such as, for example, cyclopentadiene complexes of metals such as Ti and Zr. As one skilled in the art would readily appreciate, the polyethylene polmers used herein, e.g., LLDPE, can contain various comonomers such as, for example, 1-butene, 1-hexene and 1-octene comonomers. Preferably, the polymer to be stabilized herein is polyethylene and include, but is not limited to, high density polyethylene (HDPE), low density polyethylene (LDPE) and linear low density polyethylene (LLDPE).

Polymers may also include, but are not limited to, styrenic polymers, e.g., polystyrene, poly-(p-methylstyrene), poly-(.alpha.-methylstyrene), copolymers of styrene or .alpha-methylstyrene with dienes or acrylic derivatives such as, for example, styrene/butadiene, styrene/acrylonitrile, styrene/alkyl methacrylate, styrene/maleic anhydride, styrene/maleimide, styrene/butadiene/ethyl acrylate, styrene/acrylonitrile/methylacrylate, mixtures of high impact strength from styrene copolymers and another polymer such as, for example, from a polyacrylate, a diene polymer or an ethylene/propylene/diene terpolymer; and block copolymers of styrene such as, for example, styrene/butadiene/styrene, styrene/isoprene/styrene, styrene/ethylene/butylene/styrene or styrene/ethylene/propylene styrene.

Styrenic polymers may additionally or alternatively include graft copolymers of styrene or alpha-methylstyrene such as, for example, styrene on polybutadiene, styrene on polybutadiene-styrene or polybutadiene-acrylonitrile; styrene and acrylonitrile (or methacrylonitrile) on polybutadiene and copolymers thereof, styrene and maleic anhydride or maleimide on polybutadiene; styrene, acrylonitrile and maleic anhydride or male imide on polybutadiene; styrene, acrylonitrile and methyl methacrylate on polybutadiene, styrene and alkyl acrylates or methacrylates on polybutadiene, styrene and acrylonitrile on ethylene-propylene-diene terpolymers, styrene and acrylonitrile on polyacrylates or polymethacrylates, styrene and acrylonitrile on acrylate/butadiene copolymers, as well as mixtures thereof with the styrenic copolymers indicated above.

Nitrile polymers are also useful in the polymer composition of the invention. These include, but are not limited to, homopolymers and copolymers of acrylonitrile and its analogs, such as polymethacrylonitrile, polyacrylonitrile, acrylonitrile/-butadiene polymers, acrylonitrile/alkyl acrylate polymers, acrylonitrile/alkyl methacrylate/butadiene polymers, and various ABS compositions as referred to above in regard to styrenics.

Polymers based on acrylic acids such as, for example, acrylic acid, methacrylic acid, methyl methacrylic acid and ethacrylic acid and esters thereof may also be used. Such polymers include, but are not limited to, polymethylmethacrylate, and ABS-type graft copolymers wherein all or part of the acrylonitrile-type monomer has been replaced by an acrylic acid ester or an acrylic acid amide. Polymers including other acrylic-type monomers such as, for example, acrolein, methacrolein, acrylamide and methacrylamide may also be used.

Halogen-containing polymers may also be useful. These include, but are not limited to, resins such as polychloroprene, epichlorohydrin homo- and copolymers, polyvinyl chloride, polyvinyl bromide, polyvinyl fluoride, polyvinylidene chloride, chlorinated polyethylene, chlorinated polypropylene, fluorinated polyvinylidene, brominated polyethylene, chlorinated rubber, vinyl chloride-vinylacetate copolymers, vinyl chloride-ethylene copolymer, vinyl chloride-propylene copolymer, vinyl chloride-styrene copolymer, vinyl chloride-isobutylene copolymer, vinyl chloride-vinylidene chloride copolymer, vinyl chloride-styrene-maleic anhydride terpolymer, vinyl chloride-styrene-acrylonitrile copolymer, vinyl chloride-butadiene copolymer, vinyl chloride isoprene copolymer, vinyl chloride-chlorinated propylene copolymer, vinyl chloride- vinylidene chloride-vinyl acetate tercopolymer, vinyl chloride-acrylic acid ester copolymers, vinyl chloride-maleic acid ester copolymers, vinyl chloride-methacrylic acid ester copolymers, vinyl chloride-acrylonitrile copolymer and internally plasticized polyvinyl chloride.

Other useful polymers include, but are not limited to, homopolymers and copolymers of cyclic ethers, such as polyalkylene glycols, polyethylene oxide, polypropylene oxide or copolymers thereof with bis-glycidyl ethers; polyacetals, such as polyoxymethylene and those polyoxymethylene which contain ethylene oxide as a comonomer; polyacetals modified with thermoplastic polyurethanes, acrylates or methacrylonitrile containing ABS; polyphenylene oxides and sulfides, and mixtures of polyphenylene oxides with polystyrene or polyamides; polycarbonates and polyester-carbonates; polysulfones, polyethersulfones and polyetherketones; and polyesters which are derived from dicarboxylic acids and diols and/or from hydroxycarboxylic acids or the corresponding lactones, such as polyethylene terephthalate, polybutylene terephthalate, poly-4dimethylol-cyclohexane terephthalate, poly-2(2,2,4(4-hydroxyphenyl)- propane) terephthalate and polyhydroxybenzoates as well as block copolyetheresters derived from polyethers having hydroxyl end groups.

Polyamides and copolyamides which are derived from bisamines and dicarboxylic acids and/or from aminocarboxylic acids or the corresponding lactams, such as polyamide 4, polyamide 6, polyamide 6/6, 6/10, 6/9, 6/12 and 4/6, polyamide 11, polyamide 12, aromatic polyamides obtained by condensation of m-xylene bisamine and adipic acid; polyamides prepared from hexamethylene bisamine and isophthalic or/and terephthalic acid and optionally an elastomer as modifier, for example poly-2,4,4 trimethylhexamethylene terephthalamide or poly-m-phenylene isophthalamide may be useful. Further copolymers of the aforementioned polyamides with polyolefins, olefin copolymers, ionomers or chemically bonded or grafted elastomers; or with polyethers such as, for example, with polyethylene glycol, polypropylene glycol or polytetramethylene glycols and polyamides or copolyamides modified with EPDM or ABS may be used.

Polyolefin, polyalkylene terephthalate, polyphenylene ether and styrenic resins, and mixtures thereof are more preferred, with polyethylene, polypropylene, polyethylene terephthalate, polyphenylene ether homopolymers and copolymers, polystyrene, high impact polystyrene, polycarbonates and ABS-type graft copolymers and mixtures thereof being particularly preferred.

Optional Stabilizer Components

The present compositions may optionally contain a stabilizer or mixture of stabilizers, some for synergistic effects, in an amount ranging from about 50 ppm to about 5 wt. % of the total weight of the polymer resin composition. In one embodiment, the optional stabilizer additives are present in an amount of about 0.001 to about 2 wt. %. In yet a third embodiment, the optional stabilizer additives are present in an amount of about 0.0025 to about 1 wt. %.

In one embodiment, the optional stabilizers may be selected from the additive stabilizers of the prior art such as, for example, hindered phenols, hindered amines, and the like and mixtures thereof, may be optionally added to work in combination with and augment the stabilizers of the present invention.

In one embodiment, the optional stabilizer or mixture of second stabilizers is selected from the group consisting of the phenolic antioxidants, hindered amine stabilizers, the ultraviolet light absorbers, organo-phosphorous compounds comprising of organo-phosphites and organo-phosphonites, alkaline metal salts of fatty acids, the hydrotalcites, metal oxides, epoxydized soybean oils, the hydroxyl amines, the tertiary amine oxides, thermal reaction products of tertiary amine oxides, and the thiosynergists, as further described below.

The second stabilizer additive may be an antioxidant such as, for example, alkylated mono-phenols, e.g., 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(.alpha-methylcyclohexyl)-4,6-dimethylphenol, 2,6-di-octadecyl-4-methylphenol, 2,4,6,-tricyclohexyphenol, 2,6-di-tert-butyl-4-methoxymethylphenol, and the like; alkylated hydroquinones, e.g., 2,6-di-tert-butyl-4-methoxyphenol, 2,5-di-tert-butylhydroquinone, 2,5-di-tert-amyl-hydroquinone, 2,6-diphenyl-4-octadecyloxyphenol, and the like. Other suitable antioxidants may also comprise hydroxylated thiodiphenyl ethers, non-limiting examples of which include 2,2′-thio-bis-(6-tert-butyl-4-methylphenol), 2,2′-thio-bis-(4-octylphenol), 4,4′-thio-bis-(6-tertbutyl-3-methylphenol), and 4,4′-thio-bis-(6-tert-butyl-2- methylphenol).

Alkylidene-bisphenols may be used as antioxidants. Examples include 2,2′-methylene-bis-(6-tert-butyl-4-methylphenol), 2,2′-methylene-bis-(6-tert-butyl4-ethylphenol), 2,2′-methylene-bis-(4-methyl-6-(.alpha- methylcyclohexyl)phenol), 2,2′-methylene-bis-(4-methyl-6-cyclohexyiphenol), 2,2′-methylene-bis-(6-nonyl-4-methylphenol), 2,2′-methylene-bis-(6-nonyl-4-methylphenol), 2,2′-methylene-bis-(6-(alpha-methylbenzyl)-4-nonylphenol), 2,2′-methylene-bis-(6-(.alpha,alpha-dimethylbenzyl)-4-nonyl-phenol). 2,2′-methylene-bis-(4,6-di-tert-butylphenol), 2,2′-ethylidene-bis-(6-tert-butyl-4-isobutylphenol), 4, 4′-methylene-bis-(2,6-di-tert-butylphenol), 4,4′-methylene-bis-(6-tert-butyl-2-methylphenol), 1,1-bis-(5-tert-butyl-4-hydroxy-2-methylphenol)butane 2,6-di-(3-tert-butyl-5-methyl-2-hydroxybenzyl)-4-methylphenol, 1,1,3-tris-(5-tert-butyl-4-hydroxy-2-methylphenyl)butane, 1,1-bis-(5-tert-butyl-4-hydroxy-2-methylphenyl)-3-dodecyl-mercaptobutane, ethyleneglycol-bis-(3,3 ,-bis-(3 ′-tert-butyl-4′-hydroxyphenyl)-butyrate)-di-(3-tert-butyl-4-hydroxy-5-methylpenyl)-dicyclopentadiene, di-(2-(3′-tert-butyl-2′hydroxy-5′methylbenzyl)-6-tert-butyl4-methylphenyl)terephthalate, and other phenolics such as monoacrylate esters of bisphenols such as ethylidiene bis-2,4-di-tertbutylphenol monoacrylate ester and esters of 3,5-di-butyl hydroxyphenyl propionic acid.

In one embodiment, the second stabilizer is a phenolic antioxidant selected from the group consisting of n-octadecyl, 3,5-di-tert-butyl-4-hydroxyhydrocinnamate, neopentanetetrayl, tetrakis(3,5-di-tert-butyl-4-hydroxyhydrocinnamate), tetrakis[methylene(3,5-di-tert-butyl-4-hydroxyhydrocinnamate)methane], di-n-octadecyl-3,5-di-tert-butyl4-hydroxybenzylphosphonate, 1,3,5-tris(3,5-di-tert-butyl-4-hydroxybenzyl)-isocyanurate, thiodiethylene bis(3,5-di-tert-butyl-4-hydroxyhydrocinnamate), 1,3,5-trimethyl-2,4,6-tris(3,5-di-tert-butyl-4-hydroxybenzyl)benzene, 3,6-dioxaoctamethylene bis(3-methyl-5-tert-butyl-4-hydroxyhydrocinnamate), 2,6-di-tert-butyl-p-cresol, 2,2′-ethylidene-bis(4,6-di-tert-butylphenol), 1,3,5-tris(2,6-dimethyl-4-tert-butyl-3-hydroxybenzyl) isocyanurate, 1,1,3-tris(2-methyl-4-hydroxy-5-tert-butylphenyl)butane, 1,3,5-tris[2-(3,5-di-tert-butyl-4-hydroxyhydrocinnamoyloxy)ethyl]isocyanurate, 3,5-di-(3,5-di-tert-butyl-4-hydroxybenzyl)mesitol, hexamethylene bis(3,5-di-tert-butyl-4-hyroxyhydrocinnamate), 1-(3,5-di-tert-butyl4-hydroxyanilino)-3,5-di(octylthio)-s-triazine, N,N′-hexamethylene-bis(3,5-di-tert-butyl-4-hydroxyhydrocinnamamide), calcium bis(ethyl-3,5-di-tert-butyl-4-hydroxybenzylphosphonate), ethylene bis[3,3-di(3-tert-butyl4-hydroxyphenyl)butyrate], octyl-3,5-di-tert-butyl-4-hydroxybenzylmercaptoacetate, bis(3,5-di-tert-butyl-4-hydroxyhydrocinnamoyl)hydrazide, and N,N′-bis-[2-(3,5-di-tert-butyl-4-hydroxyhydrocinnamoyloxy)ethyl]-oxamide.

In another embodiment the phenolic antioxidant is selected from the group consisting of octadecyl-3,5-di-tert-butyl-4-hydroxycinnamate, tetrakis[methylene(3,5-di-tert-butyl -4-hydroxyhydrocinnamate)]methane, 1,3,5-tris(3,5-di-tert-butyl-4-hydroxybenzyl)isocyanurate, tetrakis(3,5-di-tert-butyl-4-hydroxyhydrocinnamate), n- octadecyl 3,5-di-tert-butyl-4-hydroxyhydrocinnamate, 1,3,5-trimethyl-2,4,6-tris(3,5-di-tert-butyl4-hydroxybenzyl)benzene, 2,6-di-tert-butyl-p-cresol, and 2,2′- ethylidene-bis(4,6-di-tert-butylphenol).

In another embodiment, the second antioxidant additive is a benzyl compound such as, for example, 1,3,5-tris-(3,5-di-tert-butyl-4-hydroxybenzyl)-2,4,6-trimethylbenzene, bis-(3,5-di-tert-butyl-4-hydroxybenzyl)sulfide, isooctyl-3,5-di-tert-butyl4-hydroxybenzyl-mercaptoacetate, bis-(4-tert-butyl-3-hydroxy-2,6-dimethylbenzyl)dithiol-terephthalate. 1,3,5-tris-(3,5-di-tert-butyl-4,10-hydroxybenzyl)isocyanurate. 1,3,5-tris-(4-tert-butyl-3-hydroxy-2,6-dimethylbenzyl)isocyanurate, dioctadecyl-3,5-di-tert-butyl-4-hydroxybenzylphosphonate, calcium salt of monoethyl-3,5-di-tertbutyl-4-hydroxybenzylphosphonate, and 1,3,5-tris-(3,5-dicyclohexyl-4-hydroxybenzyl)isocyanurate.

Acylaminophenols may be used as antioxidants. Examples include, but are not limited to, 4-hydroxylauric acid anilide, 4-hydroxystearic acid anilide, 2,4-bis-octylmercapto-6-(3,5-tert-butyl-4-hydroxyanilino)-s-triazine, and octyl-N-(3,5-di-tert-butyl4-hydroxyphenyl)-carbamate.

Esters of beta-(5-tert-butyl-4-hydroxy-3-methylphenyl)- propionic acid with monohydric or polyhydric alcohols, as for example, methanol, ethanol, ethylene glycol, diethyleneglycol, triethyleneglycol, tridiethyleneglycol, neopentylglycol, 1,2-propanediol, octadecanol, 1,6-hexanediol, 1,9-nonanediol, 3-thiaundecanol, 3-thiapentadecanol, pentaerythritol, tris-hydroxyethyl isocyanurate, trimethyldexanediol, trimethylolethane, trimethylolpropane, 4-hydroxylmethyl-1-phospha-2,6,7-trioxabicyclo[2.2.2]octane, dihydroxyethyl oxalic acid diamide may also be used as antioxidants. Antioxidants may also comprise amides of beta-(3,5-di-tert-butyl-4hydroxyphenol)-propionic acid, as for example, N,N′-bis(3,5-di-tert-butyl-4-hydroxyphenylpropionyl)- hexamethylendiamnine, N,N′-bis(3,5-di-tert-butyl-4-hydroxyphenylpropionyl)trimethylenediamine, and N,N′-bis(3,5-di-tert-butyl-4-hydroxyphenylpropionyl)-hydrazine.

In one embodiment, the second stabilizer additive is selected from one of UV absorbers and light stabilizers. The ultraviolet light absorbers and light stabilizers may include 2H-benzotriazoles, benzophenones, oxanilides, alpha-cyanocinnamates, substituted benzoate esters, or nickel salts of the O-alkyl hindered phenolic benzylphosphonates. Non-limiting examples of such UV absorbers and light stabilizers include the 2-(2′-hydroxyphenyl)-benzotriazoles, such as for example, the 5′-methyl-,3′5′-di-tert-butyl-, 5′-tert-butyl-, 5′-(1,1,3,3-tetramethylbutyl)-, 5-chloro-3′,5′-di-tert-butyl-, 5-chloro-3′-tert-butyl-5′-methyl, 3′-sec-butyl-5′-tert-butyl-, 4′-octoxy, 3′,5′-ditert-amyl- and 3′,5′-bis-(alpha. alpha-dimethylbenzyl)-derivatives. Suitable 2-hydroxy-benzophenones such as for example, the 4-hydroxy-4-methoxy-, 4-octoxy, 4-decyloxy-, 4-dodecyloxy-, 4-benzyloxy, 4,2′,4′-trihydroxy-, and 2′-hydroxy-4,4′-dimethoxy derivative may also be used as UV absorbers and light stabilizers. UV absorbers and light stabilizers may also comprise esters of substituted and unsubstituted benzoic acids, such as for example, phenylsalicilate, (4-tertbutylphenyl)salicylate, (octylphenyl)salicylate, dibenzoylresorcinol, bis-(4-tert-butylbenzoyl)resorcinol, benzoylresorcinol,5-di-tert-butyl-4-hydroxybenzoic acid, 2,4-di-tert-butyl-phenyl- and 3,5-di-tert-butyl-4- hydroxybenzoate, and their—octadecyl ester, -2-methyl-4,6-di-tert-butyl-ester; and hexadecyl-3,5-di-tert-butyl-4-hydroxybenzoate.

Other UV absorbers and light stabilizers include, but are not limited to, acrylates, e.g., alpha-cyano-beta-diphenylacrylic acid ethyl ester or isooctyl ester, alpha-carbomethoxy cinnamic acid methyl ester, alpha-cyano-beta-methyl-p-methoxy-cinnamic acid methyl ester, or butyl ester; alpha-carbomethoxy-p-methoxycinnamic acid methyl ester, and N-(beta-carbomethoxy-beta-cyanovinyl)-2-methyl-indoline.

The second stabilizer additive in the form of UV absorbers and light stabilizers may also comprise oxalic acid diamides, as for example, (4,4′-di-octyloxy)oxanilide, 2,2′-di-octyloxy-5′,5′-ditert-butyloxa nilide, 2,2′-di-dodecyloxy-5′,5′di-tert-butyl-oxanilide, 2-ethoxy-2′-ethyl-oxanilide; and N,N′-bis(3-dimethylaminopropyl)-oxalamide, 2-ethoxy-5-tert-butyl-2′-ethyloxanilide, and its mixture with 2-ethoxy-2′-ethyl-5,4-di-tert-butyloxanilide, and mixtures of ortho-and para-methoxy-as well as of o- and p-ethoxy-disubstituted oxanilides.

Other examples for UV absorbers and light stabilizers may comprise nickel compounds, as for example, nickel complexes of 2,2′-thio-bis(4-(1,1,1,3-tetramethylbutyl)-phenol), such as the 1:1 or 1:2 complex, optionally with additional ligands such as n-butylamine, triethanolamine, or N-cyclohexyl-diethanolamine; nickel dibutyldithiocarbamate, nickel salts of 4-hydroxy-3,5-di-tert-butylbenzylphosphonic acid monoalkyl esters, such as the methyl, ethyl, and butyl esters; nickel complexes of ketoximes, such as 2-hydroxy-4-methyl-penyl (pentyl or phenyl?) undecyl ketoxime; and nickel complexes of 1-phenyl-4-lauroyl-5-hydroxypyrazole, optionally with additional ligands.

Sterically hindered amines may be used as UV absorbers and light stabilizers. Examples include, but are not limited to, bis(2,2,6,6-tetramethylpiperidyl)sebacate, bis5 (1,2,2,6,6-pentamethylpiperidyl)-sebacate, n-butyl-3,5-di-tert-butyl-4-hydroxybenzyl malonic acid bis(1,2,2,6,6,-pentamethylpiperidyl)ester, 4-benzoyl-2,2,6,6- tetramethylpiperidine, 4-stearyloxy-2,2-6,6-tetramethylpiperidine, 3-n-octyl-7,7,9,9-tetramethyl-1,3,8-triaza-spiro[4.5]decane-2,4-dione, di(1,2 ,2,6,6-pentamethylpiperidin-4-yl) (3,5-di-tert-butyl-4-hydroxybenzyl)- butylmalonate, tris(2,2,6,6-tetramethylpiperidin-4-yl) nitrilotriacetate, 1,2-bis(2,2,6,6-tetramethyl-3-oxopiperazin-4-yl)ethane, and 2,2,4,4-tetramethyl-7-oxa-3,20-diaza-2,1-oxodispiro[5.1.11.2]heneicosane. Amine oxides of hindered amine stabilizers are also included in the present invention. Condensation products of 1-hydroxyethyl-2,2,6,6-tetramethyl-4-hydroxy-piperidine and succinic acid, N,N′-(2,2,6,6-tetramethylpiperidyl)hexamethylendiamine and 4-tert-octylamino-2,6-dichloro-1,3,5-s-triazine, tris-(2,2,6,6-tetramethylpiperidyl)-nitrilotriacetate, tetrakis-(2,2,6,6- tetramethyl-4-piperidyl)-1,2,3,4-butane-tetra-arbonic acid, and 1,1′(1,2- ethanediyl)-bis-(3,3,5 ,5-tetramethylpiperazinone); 2,4-dichloro-6-tert-octylamino-s-triazine and 4,4′-hexamethylenebis(amino-2,2,6,6-tetramethylpiperidine), 4,4′-hexamethylenebis(amino-2,2,6-6-tetramethylpiperidine) and 1,2-dibromoethane, 2,4-dichloro-6-morpholino-s-triazine and 4,4′-hexamethylenebis(amino-2,2,6,6-tetramethylpiperidine), N,N′N″,N′″-tetrakis[(4,6-bis(butyl-(2,2,6,6-tetramethylpiperidin-4-yl)-amino-s-triazin-2-yl]-1,1-diamino4,7-diazadecane, octamethylene bis(2,2,6,6-tetramethylpiperidin-4-carboxylate), and 4,4′-ethylenebis-(2,2,6,6-tetramethylpiperazin-3-one) may also be used herein. These amines, typically called HALS (Hindered Amines Light Stabilizers) include, but are not limited to, butane tetracarboxylic acid 2,2,6,6-tetramethyl piperidinol esters. Such amines include hydroxylamines derived from hindered amines, such as di(1-hydroxy-2,2,6,6-tetramethylpiperidin-4-yl) sebacate, 1-hydroxy 2,2,6,6-tetramethyl4-benzoxypiperidine; and 1-hydroxy-2,2,6,6-tetramethyl-4-(3,5-di- tert-butyl-4-hydroxy hydrocinnamoyloxy)-piperdine; and N-(1-hydroxy-2,2,6,6-tetramethyl-piperidin-4-yl)-epsilon-caprolactam. Condensation product of 1-(2-hydroxyethyl)-2,2,6,6-tetramethyl-4-hydroxypiperidine and succinic acid, N,N′,N″,N′″-tetrakis[(4,6-bis(butyl-2,2,6,6-tetramethyl-piperidin-4-yl)amino)-s-triazine-2-yl]-1,10-diamino4,7-diazadecane, as well as mixtures of amine stabilizers containing at least one of the foregoing may also be used herein.

In one embodiment, the UV absorbers and light stabilizers may comprise hydroxyphenyl-s-triazines, as for example 2,6-bis-(2,4- dimethylphenyl)-4-(2-hydroxy-4octyloxyphenyl)-s-triazine, 2,6-bis(2,4-dimethylphenyl)-4-(2,4-dihydroxyphenyl)-s-triazine; 5 2,4-bis(2,4-dihydroxyphenyl)-6-(4-chlorophenyl)-s-triazine; 2,4-bis(2-hydroxy-4-(2-hydroxyethoxy)phenyl)-6-(4-chlorophenyl)-s-triazine;2,4-bis(2hydroxy-4- (2-hydroxyethoxy)phenyl)-6-phenyl-s-triazine; 2,4-bis(2-hydroxy-4-(2-hydroxyethoxy)-phenyl)-6-(2,4-dimethylphenyl)-s-triazine; 2,4-bis(2-hydroxy-4-(2-hydroxyethoxy)phenyl)-6-(4-bromo-phenyl)-s-triazine; 2,4-bis(2-hydroxy-4-(2-acetoryethoxy)phenyl)-6-(4-chlorophenyl)-s-triazine, and 2,4-bis(2,4-dihydroxyphenyl)-6-(2,4-dimethylphenyl)-1-s-triazine.

In yet another embodiment, metal deactivators such as, for example, N,N′-diphenyloxalic acid diamide, N-salicylal-N′-salicyloylhydrazine, N,N′-bis-salicyloylhydrazine, N,N′-bis-(3,5-di-tert-butyl-4-hydrophenylpropionyl)-2-hydrazine, salicyloylamino-1,2,4-triazole, bis-benzyliden-oxalic acid dihydrazide, oxanilide, isophthalic acid dihydrazide, sebacic acid-bis-phenylhydrazide, bis-benzylidebeoxalic acid dihydrazide, N-salicylol-N′-salicylalhydrazine, 3-salicyloyl-amino-1,2,4-triazole or N,N-bis-salicyloyl-thiopropionic acid dihydrazide may also be used.

Phosphites and phosphonites such as, for example, triphenyl phosphite, diphenylalkyl phosphites, phenyldialkyl phosphites, tris(nonyl- phenyl)phosphite, trilauryl phosphite, trioctadecyl phosphite, distearyl pentaerythritol diphosphite, tris(2,4-di-tert-butylphenyl)phosphite, diisodecyl pentaerythritol diphosphite, Bis(2,4-di-tert-butylphenyl) pentaerythritol diphosphite, Bis (2,4-di-cumylphenyl)pentaerythritol diphosphite and the like may be used in some embodiments of the presentation.

Peroxide scavengers such as, for example, the esters of beta-thiodipropionic acid such as, for example, the lauryl, stearyl, myristyl or tridecyl esters; mercaptobenzimidazole or the zinc salt of 2-mercaptobenzimidazole, zinc-dibutyldithiocarbamate, dioctadecyldisulfide, and pentaerythritol tetrakis (beta-dodecylmercapto)propionate may also be used.

The second stabilizer additive may be a hydroxylamine, for example, N,N-dibenzylhydroxylamine, N,N-diethylhydroxylamine, N,N-dioctylhydroxylamine, N,N-dilaurylhydroxylamine, N,N-ditetradecylhydroxylamine, N,N-dihexadecylhydroxylamine, N,N-dioctadecylhydroxylamine, N-hexadecyl-N-octadecylhydroxylamnine, N-heptadecyl-N-octadecylhydroxylamine, N,N-dialkylhydroxylamine, N,N-di-tert-butylhydroxylamine, N-cyclohexylhydroxylamine, N-cyclododecylhydroxylamine, N,N-dicyclohexylhydroxylamine, N,N-dibenzylhydroxylamine, N,N-didecylhydroxylamine, N,N-di(coco alkyl)hydroxylamine, N,N-di(C₂₀-C₂₂ alkyl) hydroxylamine, and N,N-dialkylhydroxylamine derived from hydrogenated tallow amine (that is, N,N-di(tallow alkyl)hydroxylamine); as well as mixtures containing any of the foregoing.

In one embodiment, the second stabilizer additive is a nitrone, for example, N-benzyl-alpha-phenyl nitrone, N-ethyl-alpha-methyl nitrone, N-octyl-alpha-heptyl nitrone, N-lauryl-alpha-undecyl nitrone, N-tetradecyl-alpha-tridecyl nitrone, N-hexadecyl-alpha-pentadecyl nitrone, N-octadecyl-alpha-heptadecylnitrone, N-hexadecyl-alpha-heptadecyl nitrone, N-octadecyl-.alpha-pentadecyl nitrone, N-heptadecyl-alpha-heptadecyl nitrone, N-octadecyl-alpha-hexadecyl nitrone, and nitrone derived from N, N-dialkylhydroxylamines derived from hydrogenated tallow amines.

In yet another embodiment, the optional second stabilizer additive is a trialkyl amine oxide, for example GENOX™EP (commercially available from GE Specialty Chemicals) and described in U.S. Pat. Nos. 6,103,798; 5,922,794; 5,880,191; and 5,844,029.

In yet another embodiment, the optional second stabilizer additive is a polyamide stabilizer such as for example, copper salts in combination with iodides and/or phosphorus compounds and salts of divalent manganese.

Basic co-stabilizers and neutralizers, for example, melamine, polyvinylpyrrolidone, dicyandiamide, triallyl cyanurate, urea derivatives, hydrazine derivatives, amines, polyamides, and polyurethanes; alkali metal salts and alkaline earth metal salts of higher fatty acids, e.g., calcium stearate, calcium stearoyl lactate, calcium lactate, zinc stearate, magnesium stearate, sodium ricinoleate, and potassium palmitate; antimony pyrocatecholate, zinc pyrocatecholate, and hydrotalcites and synthetic hydrotalcites, may also be used. In other embodiments, hydroxy carbonates, magnesium zinc hydroxycarbonates, magnesium aluminum hydroxycarbonates, and aluminum zinc hydroxycarbonates; as well as metal oxides, e.g., zinc oxide, magnesium oxide and calcium oxide, may also be used.

Nucleating agents may also be used herein. Suitable nucleating agents include, but are not limited to, 4-tert-butylbenzoic acid, adipic acid, diphenylacetic acid, sodium salt of methylene bis-2,4-dibutylphenyl, cyclic phosphite esters, sorbitol tris-benzaldehyde acetal, and sodium salt of bis(2,4-di-t-butylphenyl) phosphite, sodium salt of ethylidene bis(2,4-di-t-butyl phenyl)phosphite and the like and combinations thereof.

In one embodiment, the optional (i.e., the second) additives and stabilizers described herein are present in an amount effective to further improve the composition stability.

The stabilizer combinations may be incorporated into the polymer resins by conventional techniques, at any convenient stage prior to the manufacture of shaped articles therefrom.

Other Optional Additives

If desired optional additives other than those described hereinabove may be included, e.g., fillers and reinforcing agents such as calcium carbonate, silicates, glass fibers, asbestos, talc, kaolin, mica, barium sulfate, metal oxides and hydroxides, carbon black and graphite. Other additives may be added such as, for example, plasticizers; epoxidized vegetable oils, e.g., epoxidized soybean oils; lubricants, e.g., stearyl alcohol; emulsifiers, pigments, optical brighteners, flame proofing agents, anti-static agents, blowing agents, anti-blocking agents, clarifiers, anti-ozonants, optical brighteners, flame-proofing agents, and thiosynergists such as, for example, dilaurythiodipropionate, distearylthiodipropionate, neopentanetetrayl, and tetrakis(3-dodecylthioproprionate).

Processing Methods

The stabilizers of this invention advantageously assist with the stabilization of polymer resin compositions especially in high temperature processing against changes in melt index and/or color, even though the polymer resin may undergo a number of extrusions. The stabilizers of the present invention may readily be incorporated into the resin compositions by conventional techniques, at any convenient stage prior to the manufacture of shaped articles therefrom. For example, the stabilizer may be mixed with the resin in dry powder form, or a suspension or emulsion of the stabilizer may be mixed with a solution, suspension, or emulsion of the polymer.

The polymer resin compositions of the present invention can be prepared by a variety of methods, e.g., intimate admixing of the ingredients with any additional materials desired in the formulation. Suitable procedures include solution blending and melt blending. Because of the availability of melt blending equipment in commercial polymer processing facilities, melt processing procedures are generally preferred. Examples of equipment used in such melt compounding methods include: co-rotating and counter-rotating extruders, single screw extruders, disc-pack processors and various other types of extrusion equipment.

All of the ingredients may be added initially to the processing system, or else certain additives may be pre-compounded with each other or with a portion of the polymer resin to make a stabilizer concentrate. Those of ordinary skill in the art will be able to adjust blending times and temperatures, as well as component addition, location and sequence, without undue additional experimentation. While the stabilizers of this invention may be conveniently incorporated by conventional techniques into polymer resins before the fabrication thereof into shaped articles, it is also possible to apply the instant stabilizers by a topical application to the finished articles.

Articles comprising the phosphite stabilizer compounds of the present invention may be made by, for example, extrusion, injection molding, blow molding, rotomolding, or compaction.

All of the stabilizer ingredients may be added initially to the processing system, or else certain additives may be pre-compounded with each other or with a portion of the polymeric resin to make a stabilizer concentrate. The additives including the phosphite stabilizer of the invention may be incorporated into the resins by conventional techniques, and at any convenient stage prior to the manufacture of shaped articles. For example, the stabilizer may be mixed with the resin in dry powder form, or a suspension or emulsion of the stabilizer may be mixed with a solution, suspension, or emulsion of the polymer. In one embodiment, the stabilizer is applied as a topical application to the finished articles, e.g., fiber articles, for example, by way of a spin finish during the melt spinning process.

The compositions of the present invention can be prepared by a variety of methods, e.g., intimate admixing of the ingredients with any additional materials desired in the formulation, e.g., solution blending, melt blending, melt compounding, etc., using a variety of equipment and methods including co-rotating and counter-rotating extruders, single screw extruders, disc-pack processors and various other types of extrusion equipment.

The following non-limiting examples are illustrative of the present invention.

### EXAMPLE 1

Preparation of (2-butyl-2-ethyl-1,3-propanediol) chlorophosphite:

In this first stage, the neoalkyl chlorophosphite is prepared. Reaction equipment, including 1 liter, 4-necked reaction vessel equipped with a stirring apparatus, reflux column, distillation head, condenser, temperature probe, and dropping funnel, is cleaned and moisture is removed by heating and reducing the pressure on the system. A total of 261.22 grams (1.63 moles) of 2-butyl-2-ethyl-1,3-propanediol and 500 grams of dry heptane is placed into the reaction vessel. A sweeping of dry inert gas is passed through a scrubber to remove hydrogen chloride gas generated during the reaction. The reaction flask is cooled to approximately 5° C. using a wet ice bath. Next, 256.81 grams (1.87 moles) of phosphorus trichloride is placed into the dropping funnel and added slowly to the reaction flask. After a short period of induction time, the hydrogen chloride generation begins and the phosphorus trichloride is generally added over a period of 4 hours after the evolution of hydrogen chloride starts.

After addition of the phosphorus trichloride is complete, the reaction mixture is allowed to slowly warm to room temperature. The reaction mixture is distilled to a pot temperature of about 165° C. at atmospheric pressure to remove any heptane and excess phosphorus trichloride. The reaction mixture is cooled to approximately 35° C. and vacuum applied. The fraction is collected in distillation at a head temperature of 139-140° C. at a pressure of 16 torr, for a yield of about 92% of (2-butyl-2-Ethyl-1,3-propanediol) chlorophosphite.

### EXAMPLE 2

In another experiment with a solventless methodology, 2-butyl-2-ethyl-1,3-propanediol chlorophosphite is prepared by reacting molten 2-butyl-2-ethyl-1,3-propanediol with PCl₃ at less than 5° C., held for 24 under inert atmosphere (N₂), subsequently followed with the removal of HCl gas and then isolating the product for (2-butyl-2-ethyl-1,3-propanediol) chlorophosphite of high purity (98+%) in high yields (˜95%).

### EXAMPLE 3

Preparation of 2,4-di-tert-butylphenyl(2-butyl-2-ethyl-1,3-propanediol)phosphite

First, 2,4-di-t-butylphenol is added to the reaction vessel capable of withstanding approximately 2 torr of pressure, equipped with a stirring apparatus, reflux column, distillation head, temperature probe, and a vacuum pump capable of pulling 2-3 torr of vacuum. With stirring, the pressure is reduced to 20 torr and held for 1 hour to remove residual water from the raw material. The molten material is cooled to approximately 60° C. and the pressure in the vessel is raised to 100 torr. Exit gas is passed through a scrubber to remove any generated hydrogen chloride gas. In the next step, 2-butyl-2-ethyl-1,3-propanediol monochlorphosphite is slowly charged to the reaction vessel at 60° C. and 100 torr pressure, with the exit gas vented to a scrubber to remove generated hydrogen chloride gas. A charge ratio of 1.25 moles (257.91 grams) of 2,4-di-t-butylphenol to 1 mole (224.67 grams) of 2-butyl-2-ethyl-1,3-propanediol monochlorophosphite is used in this preparation.

For a period of about 30 minutes after the addition of the 2-butyl-2-ethyl-1,3-propanediol monochlorphosphite is complete, the pressure is reduced to about 50-70 torr and the temperature is held in the range of about 60-77° C. for about 2-4 hours.

The vacuum is broken under dry inert gas and 1 mole % of a catalyst relative to the loading of the 2-butyl-2-ethyl-1,3-propanediol monochlorphosphite is added. The reaction vessel pressure is reduced to 50 torr and the reaction temperature is held at 75-77° C. for a period of 6 hours. The reaction temperature is increased to 83-85° C. at 50 torr and held for a period of 12 hours. When the reactant feed 2-butyl-2-ethyl-1,3-propanediol monochlorphosphite is less than 1.5% by GC (Gas Chromatographic analysis), the temperature is slowly increased to 150° C.

In the final step, the pressure is then slowly reduced to 2-3 torr and the phosphite product is hard stripped to terminal conditions of 220° C reaction mixture temperature and a head temperature of greater than about185° C. The final product 2,4-di-tert-butylphenyl(2-butyl-2-ethyl-1,3-propanediol)phosphite (Phosphite-1) is viscous liquid with purity level of 95% or greater (via GC) and with a reaction yield of about 94.61%.

### EXAMPLE 4

In this experiment, Example 3 is repeated except that HCl is removed by a sweep of nitrogen gas above the surface of the reaction contents, for similar results in terms of product yield and purity level.

### EXAMPLE 5

Preparation of (2,2-dimethyl-1,3-propanediol) chlorophosphite.

A neopentylglycol chlorophosphite is first prepared with the reaction of 67.7 g of neopentyl glycol in 300 mL of methylene chloride and 111.6 g of phosphorus trichloride in a process as described in Example 1. The product is vacuum distilled at 80° C. at 18 mm of Hg, for 104.2 g of colorless neopentylglycol chlorophosphite and a yield of 95%.

### EXAMPLE 6

Preparation of 2,4-Dicumyl-(2,2-dimethyl-1,3-propanediol)phosphite

In this example, 33.72 g of neopentyl glycol chlorophosphite is reacted with 79.43 g of dry 2,4-dicumylphenol containing 1.98 g of N-methyl pyrrolidone via the procedures as described in Example 1. In the last step, the phosphite product is cooled to 40° C. and 150 mL of isopropyl alcohol is added to precipitate the product. The 2,4-dicumyl-(2,2-dimethyl-1,3-propanediol) phosphite product is filtered and dried at 70° C. under 1 torr for 4 hours. The 85 g dried product (92% yield) has melt point of 126-127.5 C and purity of 96% GC. Product is chemically identical to the one prepared by amine acceptor route.

### EXAMPLES FOR THE PREPARATION OF POLYMER COMPOSITIONS

The stabilizers of the present invention as prepared above and comparable/prior art phosphite stabilizers are compounded into a polypropylene resin, e.g., a commercially available resin from Basell under the tradename of Profax R6301.

In the examples, resin composition is blended/mixed using Turbula Blender for 30 minutes. The stabilizer used, if liquid, is pre-blended with a portion of a resin, which is then subsequently blended with the resin and mixed well using Turbula Blender. The formulation is extruded at 100 rpm from 1 inch (2.54 cm) diameter Killion extruder at 500° F. (260° C). The rpm and temperatures may be adjusted according to the resin utilized. After each of the first, third and fifth extrusions, resin pellets are compression molded into 125 mil (3.2 mm) thick plaques at 370° F. (188° C.).

The following Components are Used in the Examples in the Tables Below:

Phenol-1: Octadecyl 3,5-di(tert)-butyl-4-hydroxyhydrocinnamate, a commercially available hindered phenol form Ciba Specialty Chemicals under trade name Irganox 1076.

Phenol-2: Tetrakis (methylene 3-(3,5-di-tert-butyl-4-hydroxyphenyl) propionatemethane, a commercially available hindered phenol from Ciba Specialty Chemicals under trade name Irganox 1010.

Phosphite-1: 2,4-Di-tert-butylphenyl(2-butyl-2-ethyl-1,3-propanediol)phosphite.

Phosphite-2: 2,4,6-Tri-tert-butylphenyl(2-butyl-2-ethyl-1,3-propanediol)phosphite, a commercially available phosphite from GE Specialty Chemicals under the trade name ULTRANOX 641.

Phosphite-3: Tris(2,4-di-tert-butyl-phenyl)phosphite, a commercially available phosphite from Ciba Specialty Chemicals under trade name Irgafos 168.

Phosphite-4: Tris(nonylphenyl)phosphite with tri-isopropanolamine from GE Specialty Chemicals under trade name WESTON-399.

Phosphite-5: Tri-lauryl phosphite from GE Specialty Chemicals.

ZnO: Zinc Oxide.

CaSt: Calcium Stearate.

Example 7 is a composition comprising Profax R6301, 500 ppm of calcium stearate, and 500 ppm of 2,4-di-tert-butylphenyl (2-butyl-2-ethyl-1,3-propanediol)phosphite (Phosphite-1) of the present invention. Comparative Example 1 contains 2,4,6-tri-tert-butylphenyl (2-butyl-2-ethyl-1,3-propanediol)phosphite (Phosphite-2), a commercially available phosphite in the prior art.

The specimen samples are measured for yellowness index (YI) with a low YI value indicates less yellowing. The melt flow rate (in grams/10 minutes) per ASTM-D-1238 is also measured on the pellets after the first, third and fifth extrusions. The closer the melt flow rate after the fifth extrusion is to the melt flow rate after the first extrusion indicates the improved/desirable process stabilization. The performance of the phosphite stabilizer (Phosphite-1) of the present invention is comparable to the Phosphite-2 of the prior art, but with an improvement in handling of the product with an advantage of the odor level being low to none.

TABLE 1

| Comp. Ex./Ex. | Comp. Ex. 1 | Ex. 7 |
|---|---|---|
| CaSt | 500 | 500 |
| Phosphite-2 | 500 | — |
| Phosphite-1 | — | 500 |
| MFR | | |
| 230° C./Compound | 12.662 | 12.686 |
| 260° C./1-pass | 14.956 | 15.430 |
| 280° C./2-pass | 16.572 | 16.866 |
| 300° C./3-pass | 19.736 | 20.546 |
| 320° C./4-pass | 23.876 | 24.706 |
| YI | | |
| 230° C./Compound | 2.58 | 2.32 |
| 260° C./1-pass | 3.335 | 2.55 |
| 280° C./2-pass | 3.54 | 2.90 |
| 300° C./3-pass | 3.61 | 3.13 |
| 320° C./4-pass | 3.00 | 2.86 |

Examples 8 and 9 of Table 2: Examples 8 and 9 are compositions comprising Profax R6301, 500 ppm of calcium stearate, and 500 ppm of the phosphite of the present invention (Phosphite-1 above). Comparative Example 2 comprises Profax R6301, 500 ppm of calcium stearate and 500 ppm of phenol 2. Examples 8 and 9 gave superior color in polypropylene under the extrusion conditions as compared to Comparative Example 2.

TABLE 2

| Ex./Comp. Ex. | Ex. 8 | Ex. 9 | Comp. Ex. 2 |
|---|---|---|---|
| CaSt | 500 | 500 | 500 |
| Phenol-2 | — | — | 500 |
| Phosphite-1 | 500 | 500 | |
| MFR | | | |
| Compound | 12.678 | 13.282 | 13.522 |
| 1^{st} -pass | 16.578 | 16.388 | 18.748 |
| 3^{rd} -pass | 25.138 | 24.394 | 27.980 |
| 5^{th} -pass | 33.624 | 37.284 | 35.076 |
| YI | | | |
| Compound | 3.03 | 3.00 | 4.17 |
| 1^{st} -pass | 3.80 | 3.60 | 7.21 |
| 3^{rd} -pass | 4.42 | 4.28 | 8.47 |
| 5^{th} -pass | 4.90 | 4.70 | 9.68 |

### EXAMPLES 10-13 AND COMPARATIVE EXAMPLES 3-9 OF TABLE 3

In the examples, the resin comprising the stabilizers is blended for 30 minutes using a Turbula Blender. The stabilized resin formulation is extruded in a Killion extruder at 100 rpm from 1 inch (2.54 cm) diameter opening at 230° C. After compounding, the first, third and fifth extrusion, the resin pellets are compression molded into 125 mil (3.2 mm) thick plaques at 188° C.

Specimen yellowness index (YI) and MFR (in grams/10 minutes) per ASTM-D-1238 (190° C./2.16 Kg, 190° C./21.6 Kg, and referred to as I-2 and I-21 respectively in Table 3) are determined on the pellets after the first, third and fifth extrusions. Examples have 200 ppm of ZnO and 500 ppm of phenol-1 and respective phosphite additive as set forth in Table-3. The data is set forth below in Table 3. The data tabulated in examples 1-6 are on equal loading level of phosphites-1, phosphite-2, phosphite-3, phosphite4, and phosphite-5.

As shown in Table 3, Examples 10 and 11 containing the phosphite of the present invention (Phosphite-1) give well balanced performance by holding the molecular weight of the polymer (LLDPE) and color well.

In the examples, a polyethylene is used as the base polymer resin, i.e., a Ziegler catalyzed LLDPE. Comparative Example 9 is the comparative example comprising an unstabilized linear low density polyethylene (Ziegler catalyzed LLDPE) and 500 ppm of Phenol-1, a phenol stabilizer in the prior art. Examples 12 and 13 are the examples of the invention, with 500 ppm of Phenol-1.

On equal loading level as shown in Examples 10 and 11 of Table 3, Phosphite-1 gives a well balanced properties in LLDPE resin at 1500 ppm loading level compared to Comparative Examples 3, 4, 5 and 6 of the prior art.

In Comparative Examples 3 and 4, more crosslinking of the polymer is observed along with an increase in color. In Comparative Examples 6, better color is observed but with more crosslinking. On equal phosphorus loading basis, Examples 12 and 13 give better results than Comparative Examples 4 containing 1500 ppm of Phosphite-4. On equal phosphorus loading basis, it is rather unexpected and surprising that Example 13 which contains the phosphite of the present invention, Phosphite-1, performs better than Comparative Examples 7, which contains Phosphite-2 of the prior art.

An aging study was conducted comparing polymer resin compositions comprising the phosphite of the present invention with the phosphites of the prior art. In this study, immediately after compounding, the pellets are stored away for 1 month at 60° C. and 80% relative humidity (RH). In the examples, all aged pellets are oven dried for 2 hours at 100° C. They are then multipassed through the extruder as described in the examples above.

It has been found that the results obtained are consistent with the results observed before the humid aging studies. It has also surprisingly found that the phosphite of the present invention, Phosphite-1, as contained in Examples 10-13 gave an overall well balanced performance in polyethylene (LLDPE). It should be noted that on a structural basis, hydrolysis of Phosphite-1, is expected to be higher than the phosphite of the prior art, Phosphite-2, in polymers, and subsequently lower performance. As the data show, formulations containing Phosphite-1 performed quite well and this unexpected result is noteworthy.

TABLE 3

| | Comp. | | | Comp. | Comp. | Comp. | | | Comp. | Comp. | Comp. |
|---|---|---|---|---|---|---|---|---|---|---|---|
| | Ex. 3 | Ex. 10 | Ex. 11 | Ex. 4 | Ex. 5 | Ex. 6 | Ex. 12 | Ex. 13 | Ex. 7 | Ex. 8 | Ex. 9 |
| ZnO | 200 | 200 | 200 | 200 | 200 | 200 | 200 | 200 | 200 | 200 | 200 |
| Phenol-1 | 500 | 500 | 500 | 500 | 500 | 500 | 500 | 500 | 500 | 500 | 500 |
| Phosphite-3 | 1500 | | | | | | | | | | |
| Phosphite-1 | | 1500 | | | | | 880 | | | | |
| Phosphite-1* | | | 1500 | | | | | 880 | | | |
| Phosphite-4 | | | | 1500 | | | | | | | |
| Phosphite-2 | | | | | 1500 | | | | 980 | | |
| Phosphite-5 | | | | | | 1500 | | | | 1190 | |
| I-2 | | | | | | | | | | | |
| COMPOUND | 0.96 | 0.96 | 0.95 | 0.96 | 0.95 | 0.95 | 0.95 | 0.97 | 0.93 | 0.97 | 0.94 |
| 1ST | 0.93 | 0.97 | 0.98 | 0.92 | 0.98 | 0.95 | 0.96 | 0.93 | 0.95 | 0.91 | 0.9 |
| 3RD | 0.88 | 0.99 | 0.93 | 0.9 | 0.99 | 0.79 | 0.93 | 0.93 | 0.94 | 0.69 | 0.84 |
| 5TH | 0.8 | 0.96 | 0.97 | 0.8 | 0.98 | 0.64 | 0.84 | 0.85 | 0.84 | 0.61 | 0.76 |
| I-21 | | | | | | | | | | | |
| COMPOUND | 27.64 | 27.52 | 28.12 | 27.44 | 27.42 | 27.62 | 28.14 | 27.88 | 26.76 | 27.76 | 27.58 |
| 1^{ST} | 27.28 | 27.62 | 27.54 | 26.88 | 27.64 | 27.12 | 27.4 | 26.88 | 27.12 | 27.2 | 26.8 |
| 3^{RD} | 27.52 | 28.52 | 28.24 | 27.08 | 28.04 | 25.86 | 27.66 | 27.04 | 27.58 | 24.76 | 26.64 |
| 5^{TH} | 26.22 | 29.3 | 28.16 | 26.04 | 28.18 | 24 | 26.86 | 26.48 | 26.74 | 23.66 | 26.12 |
| YI | | | | | | | | | | | |
| COMPOUND | −5.49 | −6.5 | −6.93 | −6.22 | −6.15 | −6.76 | −6.71 | −6.76 | −6.25 | −6.73 | −5.04 |
| 1^{ST} | −1.29 | −5.44 | −6.05 | −2.93 | −4.08 | −6.13 | −5.19 | −5.44 | −3.8 | −6.07 | −1.38 |
| 3^{RD} | 2.32 | −4.68 | −5.01 | −0.5 | −2.87 | −5.58 | −4 | −4.35 | −2.34 | −5.44 | 2.41 |
| 5^{TH} | 5.38 | −3.77 | −4.46 | 1.37 | −1.93 | −5.62 | −3.43 | −3.68 | −1.63 | −5.48 | 5.74 |

Humid Aged 1 month & extrusion Studies: I-2

| | | | | | | | | | | | |
|---|---|---|---|---|---|---|---|---|---|---|---|
| COMPOUND. | 0.95 | 0.98 | 0.97 | 0.96 | 0.98 | 0.97 | 0.97 | 0.96 | 0.97 | 0.97 | 0.94 |
| 1^{st} Pass | 0.94 | 0.96 | 0.98 | 0.95 | 0.98 | 0.9 | 0.97 | 0.98 | 0.97 | 0.9 | 0.91 |
| 3rd Pass | 0.85 | 0.98 | 0.99 | 0.9 | 1 | 0.69 | 0.94 | 0.94 | 0.96 | 0.66 | 0.85 |
| 5th Pass | 0.75 | 0.95 | 0.98 | 0.79 | 0.99 | 0.59 | 0.84 | 0.83 | 0.86 | 0.57 | 0.72 |

Humid Aged 1 month & extrusion Studies: I-21

| | | | | | | | | | | | |
|---|---|---|---|---|---|---|---|---|---|---|---|
| COMPOUND | 27.26 | 27.4 | 27.16 | 27.53 | 27.57 | 27.33 | 27.67 | 27.48 | 27.88 | 28 | 27.2 |
| 1st Pass | 27.55 | 27.84 | 27.6 | 27.71 | 28.19 | 26.77 | 27.32 | 27.23 | 27.78 | 26.72 | 26.98 |
| 3rd Pass | 26.98 | 27.88 | 27.73 | 27.2 | 28.63 | 24.79 | 27.32 | 27.4 | 27.82 | 24.64 | 26.69 |
| 5th Pass | 26.5 | 28.23 | 28.18 | 26.42 | 28.99 | 24.47 | 26.46 | 26.62 | 27.59 | 24.6 | 25.74 |

*means different batch of Phosphite-1.

### EXAMPLE 14 AND COMPARATIVE EXAMPLE 10

Hydrolytic Stability Studies

In this study, a hydrolytic stability comparison was made by exposing approximately one gram of a sample of Phosphite-1 and Phosphite-2 in Table 4 by placing each sample in 20 mL scientillation vial and then into a humidity chamber (Thunder Scientific Model 2500) at 90% relative humidity at 45° C., and the weight gain is recorded over a period of time. The results set forth in Table 4 surprisingly show that the stabilizer of the present invention, Phosphite-1, has a higher stability compared to Phosphite-2 of which the phosphorus atom is more hindered. This result is particularly noteworthy and surprising.

TGA Studies

In these examples, a series of runs are conducted to measure the thermogravimetric analysis of compounds using Hi-Res TGA 2950 Thermogravimetric Analyzer from TA Instruments, where the percent weight loss of the starting phosphite is determined as a function of temperature.

In the runs, about 10+/−2 mg of material is weighed in an aluminum pan and sealed well. After the probe is placed into the sample, heating is started at a rate of 20° C. per minute from room temperature to 600° C. under the nitrogen flow at a rate of 50 mL per minute. The weight percent loss is recorded as a function of time.

As shown in Table 4, it is noted that based on the percent loss weight of the products, the phosphite of the present invention Phosphite-1 is comparable to the phosphite of the prior art, Phosphite-2.

The unexpected hydrolytic stability of compound of present invention as indicated in Table 4, Phosphite-1 after the addition of tri-isopropanolamine of about 1% by weight, under high heat and humid conditions is surprising and unexpected.

TABLE 4

| | | | | Hydrolytic stability |
|---|---|---|---|---|
| | | | | with addition of 1% of |
| | | | | tri-isopropanolamine |
| | | | | Hours to 1% wt. Gain |
| | | Temp. At 5% | Temp. At 10% | at 45 C and at 90% |
| | Compound | Weight Loss | Weight Loss | relative humidity |
| Example 14 | Phosphite-1 | 198.71 | 212.8 | 138 h |
| Comp. Ex. 10 | Phosphite-2 | 195.73 | 212.31 | 60 h |

### EXAMPLE 15 AND COMP. EX. 11-VISCOSITY MEASUREMENT

In these examples, viscosity of Phosphite-1 composition (neat) comprising the phosphite of the invention is compared to a composition known in the prior art, Phosphite-4. Viscosities are measured using the Cannon-Fenske Routine Viscometer (ASTM D 445/D 2515).

As shown in Table 5, although there is substantial differences in the viscosities of the runs at 25° C., it is interesting to note the comparable viscosities of Phosphite-1and Phosphite-4 at about 50° C., which was unexpected in this study.

TABLE 5

| | Comp. Ex. 11 | Ex. 15 |
|---|---|---|
| Temp. (° C.) | Viscosity in CPS | Viscosity in CPS |
| 25 | 6000 | 14090 |
| 40 | 1300 | 1606 |
| 50 | 525 | 504 |

### EXAMPLE 16 AND COMP. EX. 12-ODOR TEST

Comparative Example 12 of about 50 g of Phosphite-1 as prepared by amine acceptor route (Phosphite A), and not containing tri-isopropanolamine, and Example 12, another Phosphite-1, as prepared by a direct route (Phosphite B) and not containing tri-isopropanolamine, were placed in a 4 oz. wide mouth bottle at room temperature. A panel of five evaluators were asked for an odor evaluation of the product by opening the cap and breathing the air-space above the phosphites carefully. All the panelists indicated that Comparative Example 12 containing Phosphite A (prepared by amine acceptor route, and not containing tri-isopropanolamine) has a slight amine like odor. The panelists also rated Example 16 containing Phosphite B (prepared by a direct route and not containing tri-isopropanolamine) to be odorless or has almost no odor compared to Comparative Example 12.

### EXAMPLE 17

To a chromium catalyzed high density polyethylene resin (Cr-HDPE) used as the base polymer resin, 1060 ppm of 2,4-di-tert-butylphenyl(2-butyl-2-ethyl-1,3-propanediol)phosphite prepared in accordance with the procedure set forth in Example 3 above was added together with 1000 ppm Irganox™ 1010, 2000 ppm calcium stearate and 1000 ppm zinc stearate to provide a stabilized polymer.

### COMPARATIVE EXAMPLES 13 AND 14

In Comparative Example 13, 1750 ppm of tris(2,4-di-t-butylphenyl) phosphite was added together with 1000 ppm IrganoX™ 1010, 2000 ppm calcium stearate and 1000 ppm zinc stearate to a Cr-HDPE resin used as the base polymer resin to provide a stabilized polymer.

In Comparative Example 14, 2000 ppm of tris(Nonylphenyl) phosphite was added together with 1000 ppm Irganox™ 1010, 2000 ppm calcium stearate and 1000 ppm zinc stearate to a Cr-HDPE resin used as the base polymer resin to provide a stabilized polymer.

Multipass Extrusion

The Cr-HDPE comprising the stabilizers of Example 17 and Comparative Examples 13 and 14 were compounded at 230° C. under an inert atmosphere and extruded five times on a 1″ Killion extruder at 230° C. under air. The melt flow was measured on the 1^{st}, 3^{rd}, and 5^{th} pass according to ASTM method D1238-86. Color measurements were made on 3.18 mm compression molded plaques according to ASTM method D1925-70. Gas-fade testing was carried out using AATCC test method 164-1987 at 60° C.

Results and Discussion

The Cr-HDPE sample of Example 17 using the phosphite within the scope of the present invention had an excellent hydrocarbon solubility, improved hydrolytic stability, high polymer compatibility, and excellent activity for melt and color stabilization at low levels, resulting in cost effective formulations as compared to the Cr-HDPE sample of Comparative Examples 13 and 14 using phosphites outside the scope of the invention.

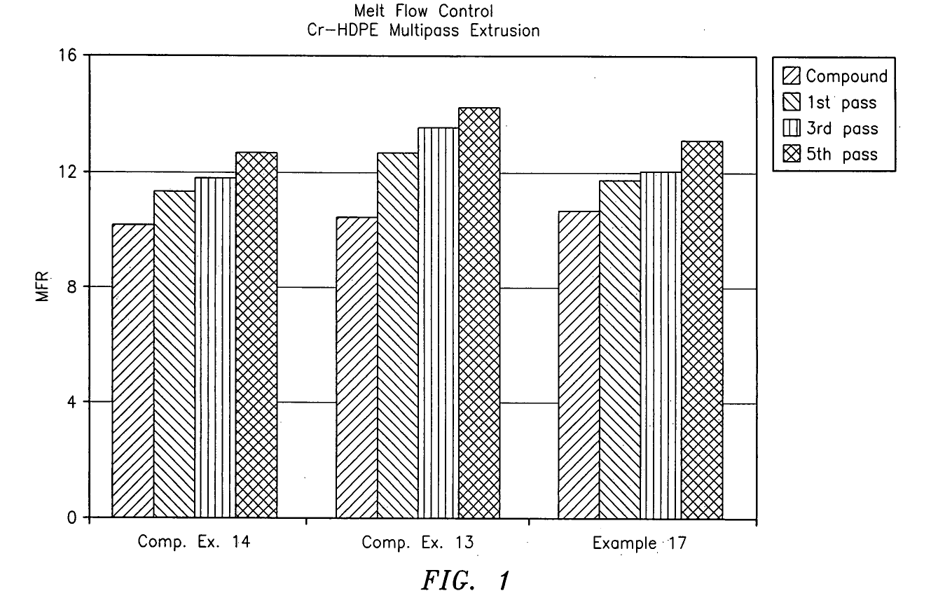

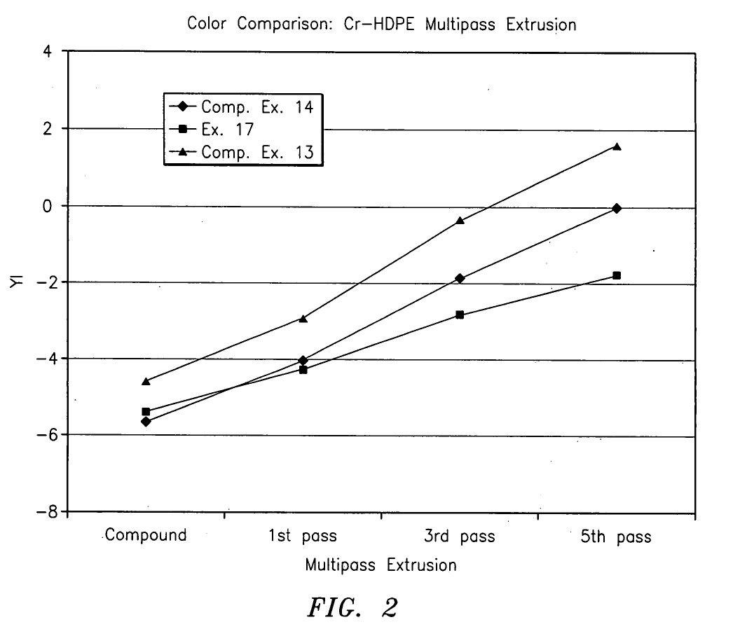

FIGS. 1 and 2 show the melt flow control and color, respectively, observed with the Cr-HDPE sample of Example 17 using a phosphite within the scope of the present invention as compared to the Cr-HDPE sample of Comparative Examples 13 and 14 using phosphites outside the scope of the invention. All three phosphites exhibited comparable molecular weight protection during multipass extrusion at 230° C. Clearly, the sample of Example 17 using a phosphite within the scope of the present invention gave better color than both samples of Comparative Examples 13 and 14.

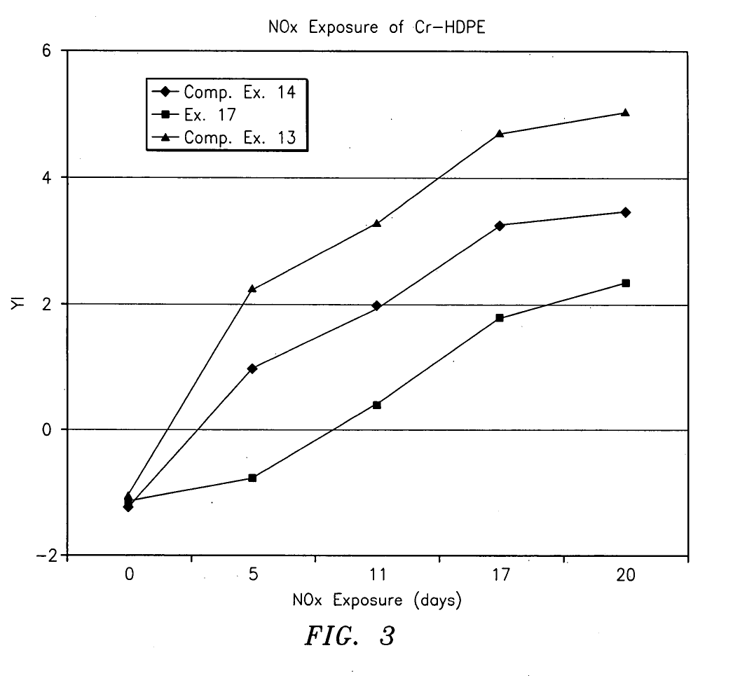

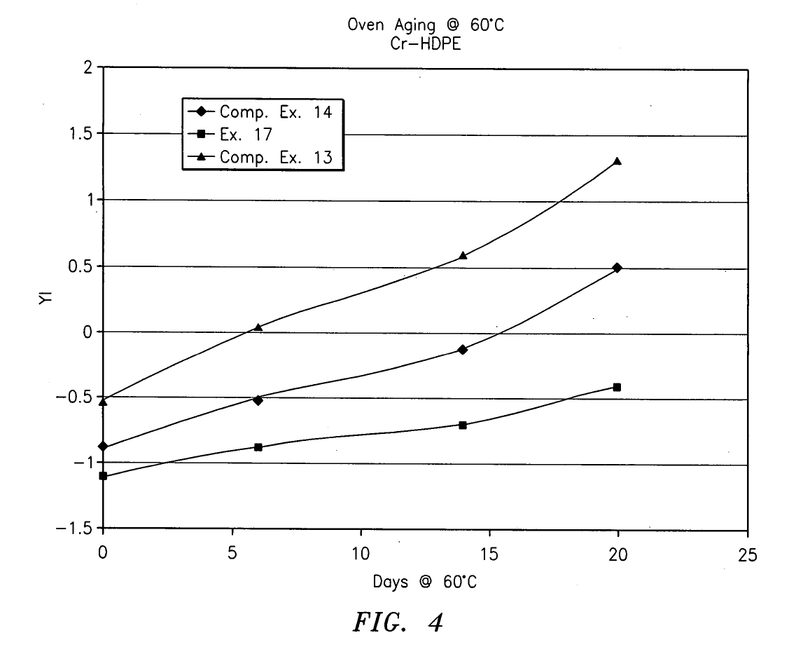

Further, when the samples were placed in an oven for thermal aging (FIG. 4), the Cr-HDPE sample of Example 17 stabilized with a phosphite within the scope of the present invention showed less color development over 20 days at 60° C. than the color development observed with both Cr-HDPE samples of Comparative Examples M and N. Additionally, exposure of the Cr-HDPE samples to environmental pollutants such as NOx gases (FIG. 3) affected the color of these samples. As the results showed the color development of Example 17 using a phosphite within the scope of the present invention was less than those observed for Comparative Examples 13 and 14 using phosphites outside the scope of the present invention. Therefore, the Cr-HDPE sample of Example 17 provided the best balance of stabilization and color during extrusion, storage, and gas fading conditions at half the dosing levels compared to the Cr-HDPE samples of Comparative Examples 13 and 14.

### EXAMPLE 18

To a Ziegler-Natta catalyzed linear low density polyethylene resin with Butene and a comonomer (ZN-LLDPE) used as the base polymer resin, 750 ppm of 2,4-di-tert-butylphenyl(2-butyl-2-ethyl-1,3-propanediol)phosphite prepared in accordance with the procedure set forth in Example 3 above was added together with 500 ppm of zinc stearate and 500 ppm Irganox 1076 to provide a stabilized polymer.

### COMPARATIVE EXAMPLES 15 AND 16

In Comparative Example 15, 1500 ppm of tris (2,4-di-tert-butylphenyl)phosphite was added together with 500 ppm of zinc stearate and 500 ppm Irganox 1076 to a ZN-LLDPE resin (C₄) used as the base polymer resin to provide a stabilized polymer.

In Comparative Example 16, 1500 ppm of tris(nonylphenyl)phosphite was added together with 500 ppm of zinc stearate and 500 ppm Irganox 1076 a ZN-LLDPE resin (C₄) used as the base polymer resin to provide a stabilized polymer.

Multipass Extrusion

The ZN-LLDPE comprising the stabilizers of Example 18 and Comparative Examples 15 and 16 were compounded at 230° C. under an inert atmosphere and extruded five times on a 1″ Killion extruder at 230° C. under air. The melt flow was measured on the 1^{st}, 3^{rd}, and 5^{th} pass according to ASTM method D1238-86. Color measurements were made on 3.18 mm compression molded plaques according to ASTM method D1925-70. Gas-fade testing was carried out using AATCC test method 164-1987 at 60° C.

Results and Discussion

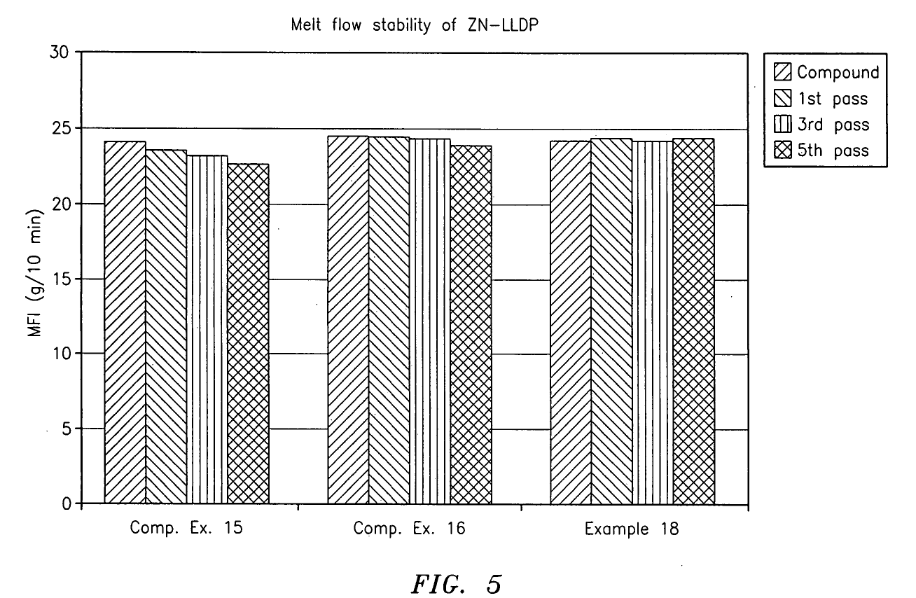

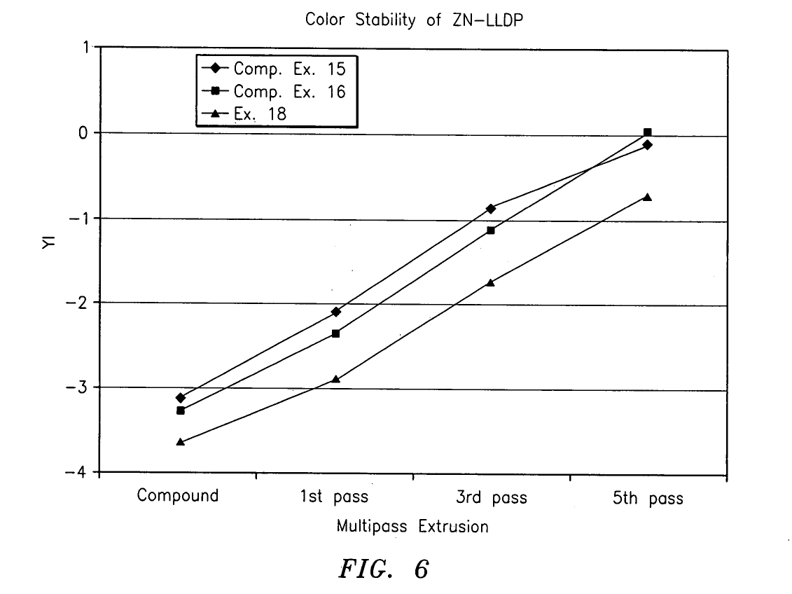

FIGS. 5 and 6 show the melt flow control and color, respectively, observed with the ZN-LLDPE sample of Example 18 using a phosphite within the scope of the present invention as compared to the ZN-LLDPE sample of Comparative Examples 15 and 16 using phosphites outside the scope of the invention. Clearly, the ZN-LLDPE sample of Example 18 using a phosphite within the scope of the present invention showed comparable performance as a melt flow stabilizer at one half the dosing level compared to the ZN-LLDPE samples of Comparative Examples 15 and 16 using a phosphite outside the scope of the invention.

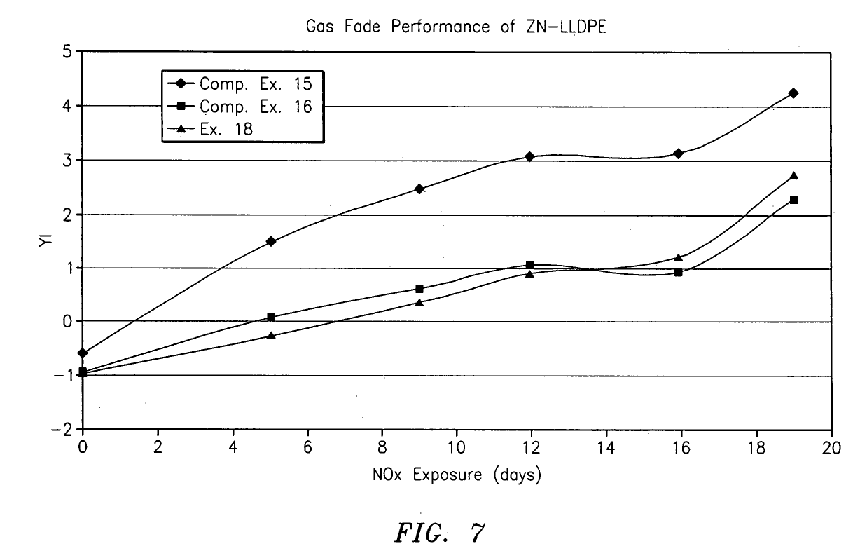

It is also noteworthy that the ZN-LLDPE sample of Example 18 exhibited superior color retention, using half the loading level of the phosphite, during multipass extrusion as compared ZN-LLDPE samples of Comparative Examples 15 and 16 using a phosphite outside the scope of the invention (FIG. 7) when exposed to NOx gases. Therefore, the ZN-LLDPE sample of Example 18 provided better gas fading resistance compared to the ZN-LLDPE samples of Comparative Examples 15 and 16.

### EXAMPLE 19

To a metallocene-catalyzed linear low density polyethylene resin (m-LLDPE) used as the base polymer resin, 750 ppm of 2,4-di-tert-butylphenyl(2-butyl-2-ethyl-1 ,3-propanediol)phosphite prepared in accordance with the procedure set forth in Example 3 above was added together with 500 ppm of Irganox 1076 to provide a stabilized polymer.

### COMPARATIVE EXAMPLES 17 AND 18

In Comparative Example 17, 1500 ppm of tris(2,4-di-t-butylphenyl) phosphite was added together with 500 ppm Irganox 1076 to a m-LLDPE resin used as the base polymer resin to provide a stabilized polymer.

In Comparative Example 18, 1500 ppm of tris(Nonylphenyl) phosphite was added together with 500 ppm Irganox 1076 to a m-LLDPE resin used as the base polymer resin to provide a stabilized polymer.

Multipass Extrusion

The m-LLDPE comprising the stabilizers of Example 19 and Comparative Examples 17 and 18 were compounded at 230° C. under an inert atmosphere and extruded five times on a 1″ Killion extruder at 230° C. under air. The melt flow was measured on the 1ₛₜ, 3rd, and 5^{th} pass according to ASTM method D1238-86. Color measurements were made on 3.18 mm compression molded plaques according to ASTM method D1925-70. Gas-fade testing was carried out using AATCC test method 164-1987 at 60° C.

Results and Discussion

The m-LLDPE sample of Example 19 using the phosphite within the scope of the present invention had an excellent hydrocarbon solubility, improved hydrolytic stability, high polymer compatibility, and excellent activity for melt and color stabilization at low levels, resulting in cost effective formulations as compared to the m-LLDPE sample of Comparative Examples 17 and 18 using phosphites outside the scope of the invention.

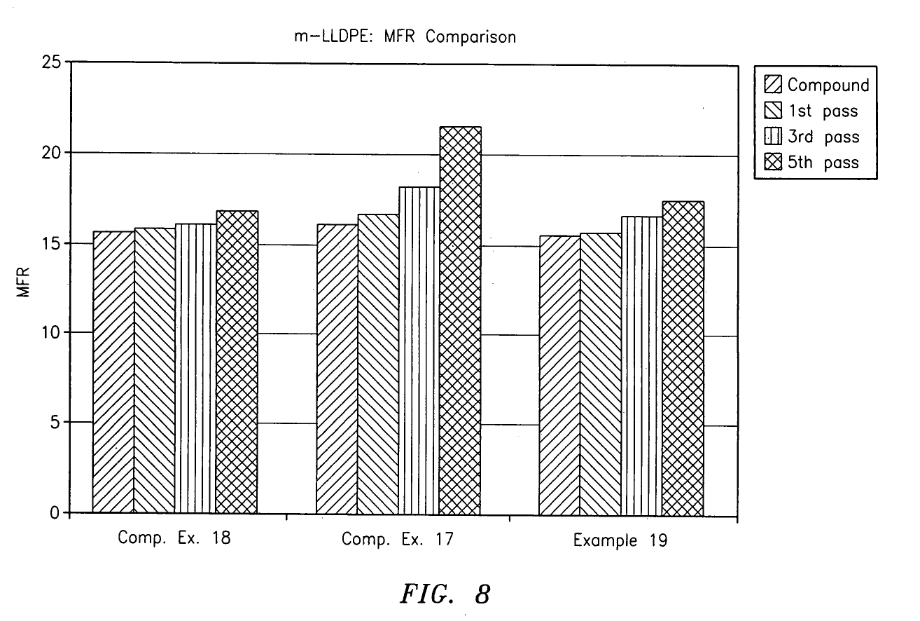

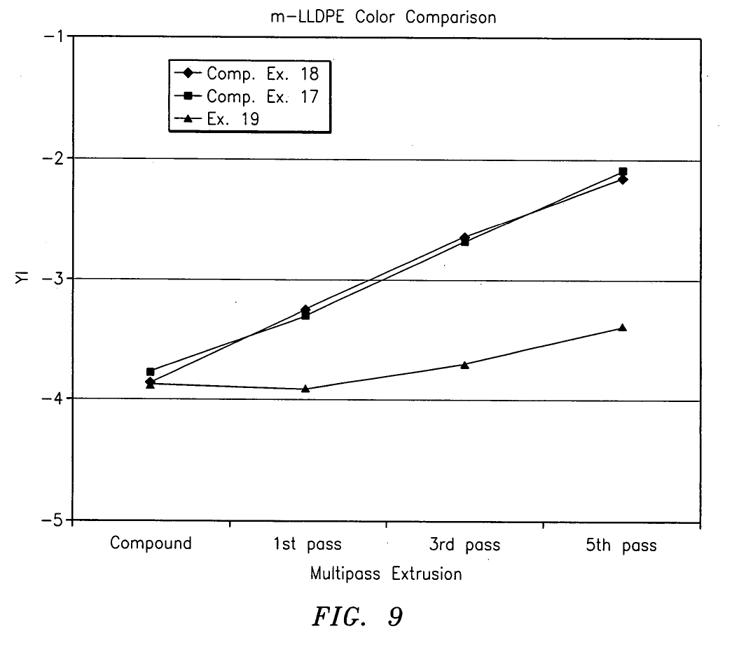

FIGS. 8 and 9 show the melt flow control and color, respectively, observed with the m-LLDPE sample of Example 19 using a phosphite within the scope of the present invention as compared to the m-LLDPE sample of Comparative Examples 17 and 18 using phosphites outside the scope of the invention. All three phosphites exhibited comparable molecular weight protection during multipass extrusion at 230° C. Clearly, the sample of Example 19 using a phosphite within the scope of the present invention gave better color than both samples of Comparative Examples 17 and 18, at half the dosing level.

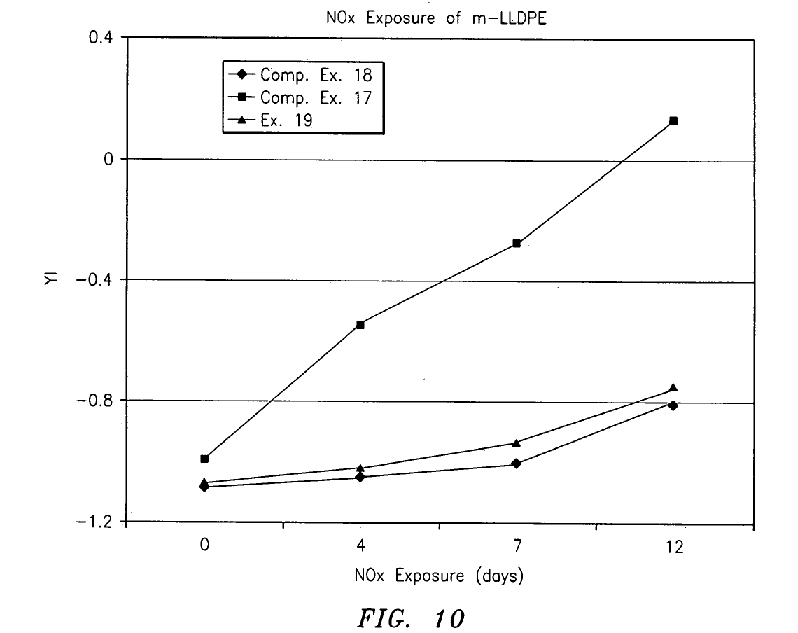

Also, the samples were exposed to environmental pollutants such as NOx gases (FIG. 10) for 12 days. As the results showed, the color development of Example 19 using a phosphite within the scope of the present invention was less than those observed for Comparative Examples 17 and 18 using phosphites outside the scope of the present invention. Therefore, the m-LLDPE sample of Example 19 provided the best balance of stabilization and color during extrusion, storage, and gas fading conditions at half the dosing levels compared to the m-LLDPE samples of Comparative Examples 17 and 18.

Conclusions for Examples 17-19 and Comparative Examples 13-18

Polymer performance evaluation employing a phosphite within the scope of the invention demonstrated a better balance of properties and exhibited improved performance attributes in a wide range of polyolefins, such as Cr-HDPE, ZN-LLDPE, and m-LLDPE. Generally, for applications, e.g., film, where gas fading properties are an important criterion, the phosphite of the present invention showed superior color retention when the polymer samples were exposed to NOx gases. That is, optimal performance for a given application can be achieved with this tailor-made liquid phosphite for better performance, less discoloration during processing, NOx exposure, and thermal aging. Furthermore, the phosphite of the present invention possessed an excellent balance of properties and performance in the polyolefins at half the dosing level compared to the phosphites outside the scope of the invention.

### EXAMPLE 20

To a polypropylene homopolymer resin used as the base polymer resin, 525 ppm of 2,4-di-tert-butylphenyl(2-butyl-2-ethyl-1,3-propanediol)phosphite prepared in accordance with the procedure set forth in Example 3 above was added together with 600 ppm of Irganox 1010 and 300 DHT-4A (Magnesium aluminum hydrotalcite) to provide a stabilized polymer.

### COMPARATIVE EXAMPLES 19 AND 20

In Comparative Example 19, 600 ppm of Phosphite-2 was added together with 600 ppm Irganox 1010 and 300 ppm DHT-4A to a propylene homopolymer resin used as the base polymer resin to provide a stabilized polymer.

In Comparative Example 20, 865 ppm of Phosphite-3 was added together with 600 ppm Irganox 1010 and 300 ppm DHT-4A to a propylene homopolymer resin used as the base polymer resin to provide a stabilized polymer.

Multipass Extrusion

The propylene homopolymer comprising the stabilizers of Example 20 and Comparative Examples 19 and 20 were compounded at 230° C. under an inert atmosphere and extruded five times on a 1″ Killion extruder at 230° C. under air. The melt flow was measured on the 1^{st}, 3^{rd}, 5^{th} pass according to ASTM method D1238-86. Color measurements were made on 3.18 mm compression molded plaques according to ASTM method D1925-70.

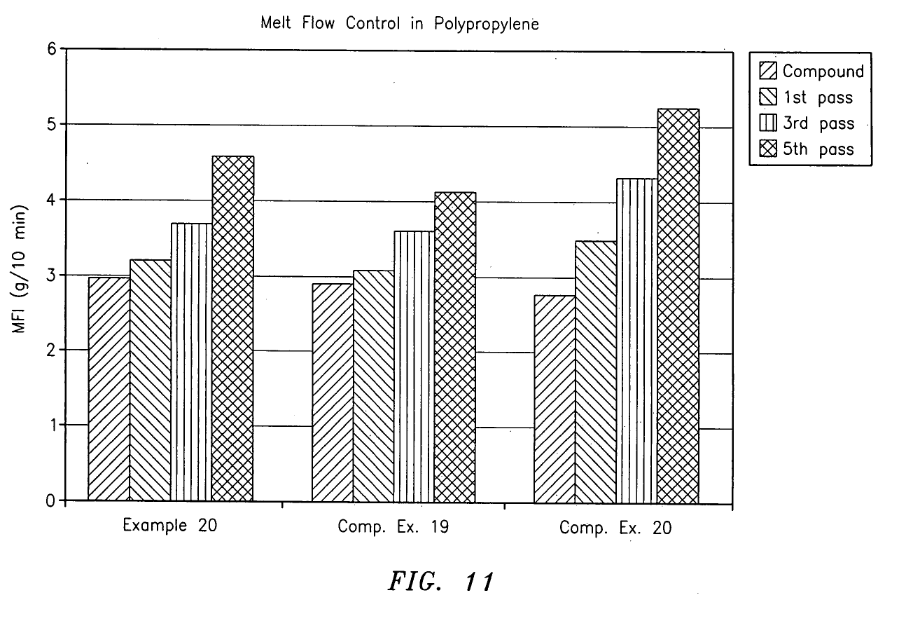

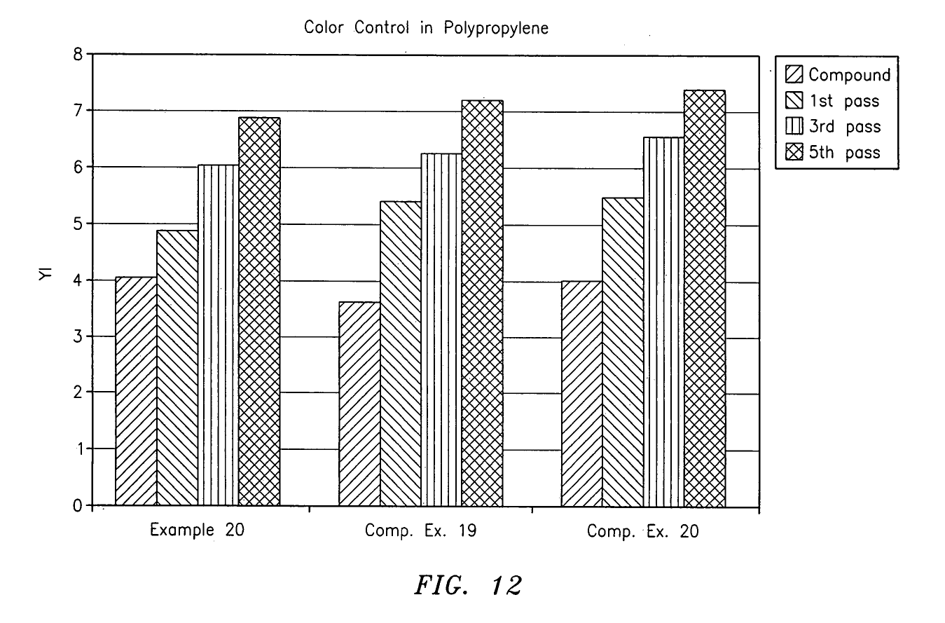

FIGS. 11 and 12 show the melt flow control and color, respectively, observed with the m-LLDPE sample of Example 20 using a phosphite within the scope of the present invention as compared to the m-LLDPE sample of Comparative Examples 19 and 20 using phosphites outside the scope of the invention. All three phosphites exhibited comparable molecular weight protection during multipass extrusion at 230° C. The sample of Example 20 using a phosphite within the scope of the present invention gave better color than both samples of Comparative Examples 19 and 20.

### In-Polymer Hydrolytic Stability Example and Comparative Examples

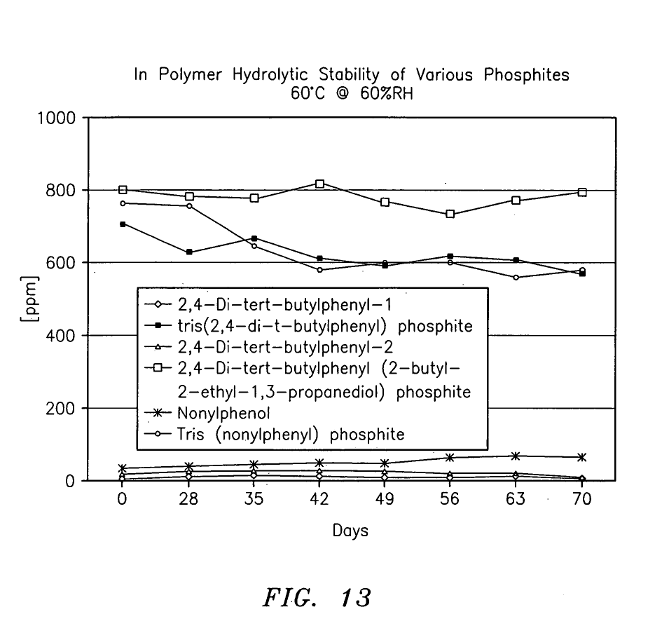

Polypropylene samples (Profax 6301) were compounded on a 1″ Killion extruder at 230° C. under inert atmosphere using the following components: (1) 2,4-di-tert-butylphenyl(2-butyl-2-ethyl-1,3-propanediol)phosphite prepared in accordance with the procedure set forth in Example 3 above; (2) 2,4-di-tert-butylphenyl-1 which is the hydrolysis product of the 2,4-di-tert-butylphenyl(2-butyl-2-ethyl-1,3-propanediol)phosphite prepared in accordance with the procedure set forth in Example 3 above, (3) 2,4-di-tert-butylphenyl-2 which is the hydrolysis product of tris(2,4-di-tert-butylphenyl)phosphite, (4) nonylphenol and (5) tris(nonylphenyl)phosphite. The polypropylene samples were then exposed to 60° C. and 60% relative humidity over a 70 day period. At various intervals samples were taken from the humidity cabinet and analyzed by HPLC. The results are summarized in FIG. 13.

It will be understood that various modifications may be made to the embodiments disclosed herein. Therefore, the above description should not be construed as limiting, but merely as exemplifications of preferred embodiments. Those skilled in the art will envision other modifications within the scope and spirit of the claims appended hereto.

1. A process for the preparation of a neo diol phosphite stabilizer of formula (A): 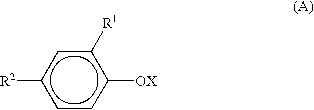
wherein the OX group is hindered by at least one R¹; R¹ and R² are independently alkyl groups having from 1 to 9 carbon atoms and wherein the R¹ and R² alkyl groups have a combined total of carbon atoms of at least 5, or formula (B) 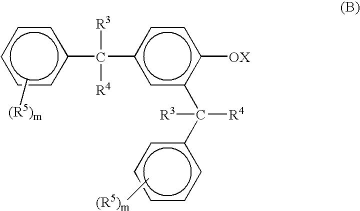
wherein R³ and R⁴ are independently alkyl of 1 to 6 carbon atoms; R⁵ is a hydrogen, a halogen, or an alkyl of from 1 to 12 carbon atoms; m has a value from 0 to 5; and wherein X is one of formula (C): 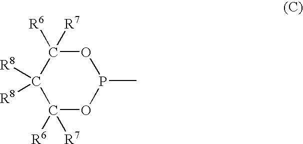
wherein R⁶ and R⁷ are independently hydrogen, halogen, or an alkyl group from 1 to 3 carbon atoms and R⁸ is independently alkyl groups having 1 to 12 carbon atoms; or of the general formulae (D): 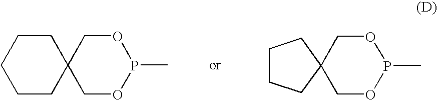
the method comprising the steps of:
(a) reacting in the absence of a solvent at least one phenol derivative of formula A or formula B, wherein X is hydrogen, with a neoalkyl halophosphite derivative of formula C or formula D, at a temperature of about 40 to about 250° C.; and,
(b) removing any unreacted excess of substituted phenol and neo diol phosphite from said reaction under reduced pressure after the conversion to the phosphite product is at least over about 70% in the reaction product.

2. The process of claim 1, wherein the reaction is carried out in the presence of at least one catalyst selected from the group consisting of amines, ammonium salts, amides of carboxylic acid, amides of carbonic acid, non-aromatic N-containing heterocyclic compounds, non-aromatic N-containing heterocyclic salts, phosphines, esters of phosphoric acids, esters of phosphonic acids, and mixtures thereof.

3. The process of claim 1, wherein the reaction is carried out in the absence of a catalyst.

4. The process of claim 2, wherein the catalyst is an amide of a carboxylic acid and is selected from the group of formamide, oxamide, dimethylformamide, acetamide, N,N-diemethylacetamide, picoanilide, benzamide, terephthalamide, trimellitamide, N,N-dimethylformamide, N,N-dimethylacetamide, N-methylpyrrolidone and mixtures thereof.

5. The process of claim 1, wherein the phosphite stabilizer is selected from the group consisting of 2,4-di-tert-butylphenyl-(2-butyl-2-ethyl-1,3-propanediol)phosphite, 2,4-di-tert-butylphenyl(2,2-dimethyl-1,3-propanediol)phosphite, 2,4-dicumyl(2,2-dimethyl-1,3-propanediol)phosphite, and 2,4-dicumyl(2-butyl-2-ethyl-1,3-propanediol)phosphite.

6. A phosphite composition prepared by the process of claim 1 having low to no odor.

7. A polymeric composition comprising (a) a polymer selected from the group of thermoplastic and thermoset resins and (b) a stabilizing effective amount of a phosphite composition having low to no odor, the phosphite composition being of the formula (A): 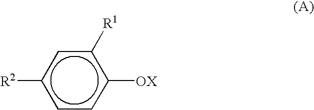
wherein the OX group is hindered by at least one R¹; R¹ and R² are independently alkyl groups having from 1 to 9 carbon atoms and wherein the R¹ and R² alkyl groups have a combined total of carbon atoms of at least 5, or formula (B) 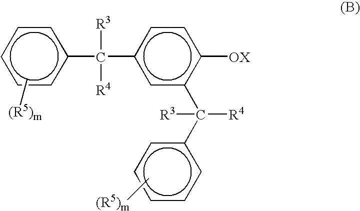
wherein R³ and R⁴ are independently alkyl of from 1 to 6 carbon atoms; R⁵ is a hydrogen, a halogen, or an alkyl of from 1 to 12 carbon atoms; m has a value from 0 to 5 and wherein X is of one of formula (C): 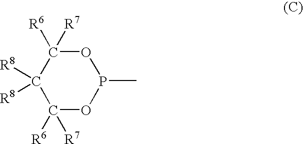
wherein R⁶ and R⁷ are independently hydrogen, halogen, or an alkyl group from 1 to 3 carbon atoms; and R⁸ is independently alkyl groups having 1 to 12 carbon atoms, or of the general formulae (D):

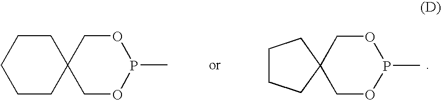

8. The polymeric composition of claim 7, wherein the phosphite composition is present in an amount of about 50 ppm to 5 wt. %, based on the total weight of the polymeric composition.

9. The polymeric composition of claim 7, wherein the phosphite composition is present in an amount of about 0.0025 to about 1 wt. %, based on the total weight of the polymeric composition.

10. The polymeric composition of claim 7, wherein the polymer is selected from the group consisting of polyethylene, polypropylene, and mixtures thereof.

11. The polymeric composition of claim 7, wherein the polymer is selected from the group consisting of low density polyethylene, medium density polyethylene, high density polyethylene, very low density polyethylene, linear low density polyethylene, ultra low density polyethylene, ethylene/vinyl acetate copolymer, ethylene/propylene copolymer, and copolymers of ethylene or propylene with alpha-olefins having greater than or equal to 4 carbon atoms.

12. The polymeric composition of claim 7, wherein the polymer is selected from the group consisting of polyolefins, polyesters, polycarbonates, polyurethanes, polysulfones, rubber modified graft copolymers, polyamides, polyimides, polyetherimides, polystyrene, polyethersulfones, polyphenylene ethers, poly(alkenylaromatic) polymers, polycarbonates, acrylic polymers, polyamides, polyacetals, polyvinylhalides, and mixtures thereof.

13. The polymeric composition of claim 7, wherein the polymer is selected from the group consisting of chromium-catalyzed polyethylenes, Ziegler Natta-catalyzed polyethylenes, single site-catalyzed polyethylenes, free radical initiated polyethylenes (LDPE) and mixtures thereof.

14. The polymeric composition of claim 13, wherein the chromium-catalyzed polyethylene is a chromium-catalyzed high density polyethylene.

15. The polymeric composition of claim 13, wherein the single site-catalyzed polyethylenes are metallocene-catalyzed polyethylenes.

16. The polymeric composition of claim 15, wherein the metallocene-catalyzed polyethylene is a metallocene-catalyzed linear low density polyethylene.

17. The polymeric composition of claim 7, further comprising at least one of a stabilizer, a neutralizer, or a filler.

18. The polymeric composition of claim 7, further comprising at least a stabilizer selected from the group consisting of a phenolic antioxidant, a hydroxycarbonate, 3-arylbenzofuranone, a hindered amine stabilizer, an ultraviolet light absorber, a phosphite, a phosphonite, a alkaline metal salt of fatty acid, a metal oxide, a hydrotalcite, an epoxydized soybean oil, a hydroxylamine, a tertiary amine oxide, and a thiosynergist.

19. The polymeric composition of claim 7, further comprising at least a neutralizer selected from the group consisting of metal salts of fatty acids, metal oxides, and metal hydroxycarbonates.

20. The polymeric composition of claim 19, wherein said neutralizer comprises at least one of zinc stearate, magnesium stearate, calcium stearate, calcium oxide, magnesium oxide, manganese oxide, and zinc oxide.

21. The polymeric composition of claim 19, wherein the metal hydroxycarbonate is selected from the group consisting of magnesium aluminum hydroxycarbonate, zinc aluminum hydroxycarbonate, zinc magnesium hydroxycarbonate and combinations thereof.

22. The polymeric composition of claim 7, further comprising at least a filler selected from the group consisting of glass, mica, silica, titanium oxide, and carbon.

23. An article of manufacture comprising the polymeric composition of claim 7.

24. A stabilized composition comprising:
(a) a polyethylene resin;
(b) a stabilizing effective amount of a phosphite composition having low to no odor, the phosphite composition having the formula (A): 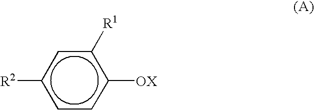
wherein OX group is hindered by at least one R¹; R¹ and R² are independently alkyl groups having from 1 to 9 carbon atoms and wherein the R¹ and R² alkyl groups have a combined total of carbon atoms of at least 5, and X is of the general formula (C): 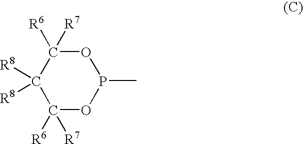
wherein R⁶ and R⁷ are independently hydrogen, halogen, or an alkyl group having 1 to 3 carbon atoms and R⁸ is independently alkyl groups having 1 to 12 carbon atoms, or formulae (D): 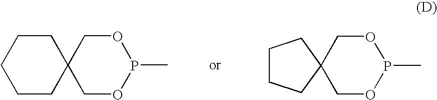
(c) a neutralizer selected from the group consisting of alkali metal salts of higher fatty acids, alkaline earth metal salts of higher fatty acids, hydroxy carbonates, and metal oxides; and,
(d) an antioxidant selected from the group consisting of octadecyl-3,5-di-tert-butyl-4-hydroxyhydrocinnamate, tetrakis[methylene(3,5-di-tert-butyl-4-hydroxyhydrocinnamate)]methane, 1,3,5-tris(3,5-di-tert-butyl-4-hydroxybenzyl)isocyanurate and combinations thereof.

25. The stabilized composition of claim 24, wherein the polyethylene is at least one polyethylene selected from the group consisting of low density polyethylene, medium density polyethylene, high density polyethylene, very low density polyethylene, linear low density polyethylene, ultra low density polyethylene, ethylene/vinyl acetate copolymer, ethylene/propylene copolymer, and copolymers of ethylene or propylene with alpha-olefins having greater than or equal to 4 carbon atoms.

26. The stabilized composition of claim 25, wherein the composition further comprises at least one additional component selected from the group consisting of a stabilizer, filler, and combinations thereof.

27. The stabilized composition of claim 26, wherein the stabilizer is selected from the group consisting of 3-arylbenzofuranones, hindered amine stabilizers, ultraviolet light absorbers, phosphonites, hydroxylamines, tertiary amine oxides, thiosynergists, and combinations thereof.

28. The stabilized composition of claim 26, wherein the filler is selected from group consisting of glass, mica, silica, titanium oxide and carbon.

29. The stabilized composition of claim 24, wherein the polyethylene resin is selected from the group consisting of chromium-catalyzed polyethylenes, Ziegler Natta-catalyzed polyethylenes, single site-catalyzed polyethylenes, free radical initiated polyethylenes (LDPE) and mixtures thereof.

30. The stabilized composition of claim 29, wherein the single site-catalyzed polyethylenes are metallocene-catalyzed polyethylenes.

31. The stabilized composition of claim 30, wherein the metallocene-catalyzed polyethylene is a metallocene-catalyzed linear low density polyethylene.

32. The stabilized composition of claim 29, wherein the chromium-catalyzed polyethylene is a chromium-catalyzed high density polyethylene.
